(19) United States
(12) Patent Application Publication
(10) Pub. No.: US 2025/0148464 A1
(43) Pub. Date: May 8, 2025

(54) SYSTEM, METHOD, AND APPARATUS FOR DOWNLOADING CONTENT DIRECTLY INTO A WEARABLE DEVICE

(71) Applicant: Onanoff Limited Company (Ltd.), Kowloon Bay (HK)

(72) Inventors: Petur Hannes Olafsson, Hong Kong (CN); Simon Weston, Miyagi-ken (JP); Charles R. Watson, Christchurch (NZ)

(73) Assignee: Onanoff Limited Company (Ltd.), Kowloon Bay (HK)

(21) Appl. No.: 19/015,879

(22) Filed: Jan. 10, 2025

Related U.S. Application Data
(63) Continuation-in-part of application No. 18/540,922, filed on Dec. 15, 2023.
Application No. 18/540,922 is a continuation of application No. 18/117,578, filed on Mar. 6, 2023, now Pat. No. 11,983,714.
Application No. 18/117,578 is a continuation-in-part of application No. 17/492,907, filed on Oct. 4, 2021, now Pat. No. 11,599,146.
(60) Provisional application No. 63/189,451, filed on May 17, 2021.
(60) Provisional application No. 63/087,627, filed on Oct. 5, 2020.

(51) Int. Cl. G06Q 20/40; G06K 7/10

(52) U.S. Cl. CPC G06Q 20/401; G06K 7/10396; G06Q 2220/18

(57) ABSTRACT

A set of headphones has an audio system, a control system with a graphical user interface (GUI) and a digital content management system including a database of digital content, a user authentication system, a processor, and a memory storing executable instructions. The processor is configured to validate a user, download and store digital content upon user authentication, and decrypt and decode the digital content for output via the audio system to an authenticated user. A set of headphones enable one or more users to engage with story content with one or more biometric sensors to capture physiological and emotional responses, such as heart rate, skin conductivity, and/or motion, which are analyzed in real time by one or more of the processors. This adaptive system dynamically modifies the narrative path and content delivery based on the user's responses, creating personalized and immersive storytelling experiences.

This application is a Continuation-In-Part, entitled, “SYSTEM, METHOD, AND APPARATUS FOR DOWNLOADING CONTENT DIRECTLY INTO A WEARABLE DEVICE” claiming priority to co-pending U.S. Continuation patent application Ser. No. 18/540,922, filed on Dec. 15, 2023, claiming priority under 35 USC 120 to U.S. application Ser. No. 18/117,578, filed Mar. 6, 2023, which issued as U.S. Pat. No. 11,983,714 on Apr. 24, 2024, which is a U.S. CIP application claiming priority to U.S. Non-Provisional patent application Ser. No. 17/492,907 filed Oct. 4, 2021, which issued as U.S. Pat. No. 11,599,146 on Feb. 15, 2023, which claims priority to U.S. Provisional Patent Application Ser. No. 63/087,627 filed on Oct. 5, 2020 and to U.S. Provisional Patent Application Ser. No. 63/189,451 filed on May 17, 2021, the contents of all of which are hereby incorporated by reference in their entireties.

### FIELD

The field of the invention and its embodiments relate to a system, a method, and an apparatus for the secure management of digital content to a plurality of devices, each of the devices utilizing a respective object associated with a corresponding device to provide for a shared playback experience of the devices' digital content while addressing commercial concerns regarding digital content distribution and copyright.

### BACKGROUND

MP3 players may play a piece of music from information stored in the MP3 player without the use of a CD. Specifically, MP3 is a coding format for digital audio. However, MP3 players are not child-friendly, due to the associated risk of damage by dropping such device. Additionally, such MP3 players are difficult and confusing for children to use. Furthermore, for such devices, it becomes difficult to protect the rights associated with the digital content streamed from or downloaded from the Internet. Thus, what is needed is a child-friendly system for the secure management of the supply of digital content to a wearable device from a server.

Examples of related art include:

U.S. Pat. No. 8,160,495 B2 describes a portable wireless communications subscriber audio and/or video player apparatus and system and method for selecting, requesting, downloading, and playing audio and/or video data content files from an Internet-based database server. The wireless link is preferably implemented in accordance with the WIFI protocol, which allows connectivity to the Internet by being in proximity with a local base station or WIFI hotspot (i.e., publicly available local wireless access hub connected to the Internet). The portable wireless communications subscriber audio and/or video player apparatus and system preferably include a security means for monitoring and blocking unauthorized use of the player apparatus and system. The player apparatus further preferably has the capability to communicate with other neighboring player apparatus for the purpose of exchanging content data files, playlists and personal messages.

U.S. Pat. No. 7,770,226 B2 describes a method and system of synchronizing data between a contents providing system and a portable device via network.

U.S. Pat. No. 10,721,550 B2 describes systems and methods of detecting headphone rotation to properly process user input to the headphones.

WO 2017/129349 A1, WO 2015/104222 A1, DE 102014000075 A1, and U.S. Design Pat. No. 0822640 S describe a toy for playing back music or a narrated story. The toy includes a loudspeaker or a loudspeaker terminal, a sensor that may detect, within an area in the surroundings of the sensor, a property or a change in a property of said surroundings, and a control unit that may actuate the loudspeaker or the loudspeaker terminal to play back music or a narrated story when the sensor senses, within the area in the surroundings of the sensor, a certain property or a certain change in a property of the surroundings or when the control unit detects a certain change in the property sensed by the sensor. Toy identification and a device for transmitting a signal that is dependent of the toy identification are also provided by these references.

WO 2006/048668 A1 describes a computerized teaching apparatus comprises: a plurality of items (9), a reader (15) and a computer (1). Each item (9) comprises a computer-readable medium arranged to store data that corresponds to a physical attribute of the item. The reader (15) is arranged to generate input signals, each input signal representing the data stored on the computer-readable medium of one item (9). The computer (1) is programmed to receive the plurality of input signals sequentially. The computer is further arranged to generate, in response to a detection of a stored predetermined combination of input signals, an output signal representative of that combination.

U.S. Pat. No. 8,287,327 B1 describes an interactive intelligent play set, method, and apparatus that include a principle toy, a plurality of action figures, and/or play accessories. An intelligent play set identifies and tracks action figures and/or play accessories used by a player during a play session, provides interactions based on the specific action figures, accessories, or combinations thereof, used by a player during game play, provides interactions based on the history of how a player has interacted with the set during previous play sessions, and/or enables a player to construct new interactions between the various play pieces of the play set, using basic interactions as building blocks.

U.S. Published Patent Application No. 2008/0153594 A1 describes an entertainment system that comprises at least one handheld controller with a plurality of accelerometers and a touch screen interface. The system further includes a base station and an accessory box. The base station routs signals containing data and information from the handheld controllers and the accessory box to a computing apparatus that is in communication with a game portal residing on a server on a network. Game play is enabled by the server on the entertainment system.

WO 2006/058204 A3 describes an electronic game board (18) for use in a DVD gaming system (10) that includes: a DVD player (12), where DVD media (14) incorporating commands and audio visual content is accessed by the DVD player (12) as part of game play. The electronic board (12) may be used with play piece (34) and may be configured to determine the identity and location of a play piece (34) on the electronic board (18), to wirelessly transmit location data to the DVD player (12), to determine the location of finger contact on the board surface instead of play piece location, and to receive transmissions from the DVD player. The board (18) may include command inputs such as buttons, switches, or joysticks to be used as part of game play. The board (18) may include a display for presenting information or pictures to players. The board (18) may overlay displaying different playing surfaces and playing spaces.

U.S. Pat. No. 10,362,399 B1 describes systems and methods of detecting headphone orientation.

U.S. Published Patent Application No. 2006/0123053 describes a personalized content system that enables a user with a communications device to convert and/or passively receive pre-selected content from multiple resources.

U.S. Pat. No. 9,009,594 B2 describes content gestures. In examples, one or more controls are output to control output of content and for display in a user interface by a computing device. An input is recognized, by the computing device, which was detected using a camera as a gesture to interact with a particular one of the controls to control the output of the content.

U.S. Pat. No. 10,068,568 B2 describes systems, devices and methods for segmentation of content. In one aspect, a method may include receiving content associated with speech, text, or closed captioning data. The speech, the text, or the closed captioning data may be analyzed to derive at least one of a topic, subject, or event for at least a portion of the content. The content may be divided into two or more content segments based on the analyzing. At least one of the topic, the subject, or the event may be associated with at least one of the two or more content segments based on the analyzing. At least one of the two or more content segments may then be published such that each of the two or more content segments is individually accessible.

TWM599457U describes a wearable device that changes the rhythm of music based on data received from sensors of the wearable device.

U.S. Pat. No. 10,133,900 B2 describes a method for controlling the output of contextual information to assist a user in performing a sequence of activities using a computing device. The computing device includes or is coupled to at least one wearable sensor and at least one output device for providing contextual information. The method includes numerous process steps, such as: identifying, using sensor information from the at least one sensor, an activity being performed by the user; and selecting and controlling the output of contextual information based on the activity being performed by the user. The contextual information is being output from the at least one output device to a user to assist the user in performing the identified activity.

U.S. Published Patent Application No. 2013/0226930 A1 describes a method for indexing multimedia content. The method includes numerous process steps, such as: segmenting the multimedia content, by a computer, into a plurality of segments; identifying, by a computer, for each segment, one or more features present in the segment, where the features are of respective media types; identifying, by a computer, for each identified feature in each segment, one or more respective keywords associated the identified feature; and determining, by a computer, for each identified keyword associated with an identified feature in a given segment, a respective relevance of the keyword to the given segment, where the respective relevance is dependent on a weight associated with the respective media type of the identified feature.

U.S. Published Patent Application No. 2008/0165141 A1 describes a system, method, and software for implementing gestures with touch sensitive devices for managing and editing media files on a computing device or system. Specifically, gestural inputs of a human hand over a touch/proximity sensitive device may be used to control, edit, and manipulate files, such as media files including without limitation graphical files, photo files and video files.

U.S. Published Patent Application No. 2009/0251244 A1 describes an improved field emission system and method that involves field emission structures having electric or magnetic field sources. The magnitudes, polarities, and positions of the magnetic or electric field sources are configured to have desirable correlation properties, which may be in accordance with a code. The correlation properties correspond to a desired spatial force function where spatial forces between field emission structures correspond to relative alignment, separation distance, and the spatial force function.

Many current digital content devices face challenges in the realm of audio content consumption, primarily due to their lack of portability and content limitations. Some existing devices, which have specific dimensions and weight, pose practical issues for families seeking a versatile audio solution that may adapt to various environments. Their bulkiness makes them impractical for on-the-go use, leading to frustration among users who desire a more flexible option. Thus, there is a need for a digital content device to address these portability concerns by offering a lightweight and compact audio solution suitable for both home and travel use.

Moreover, the content access model employed by current digital content devices presents additional limitations. For example, some customers are required to pay for each individual story, which restricts their access to a broader content library and creates a barrier to flexible listening experiences. Consumers often increasingly seek expansive and diverse content libraries without the burden of constant additional purchases. In response, some digital content providers provide an extensive content library available through a monthly subscription model, offering households a cost-effective means of accessing a wide range of audio options. This model aligns with the growing trend in the U.S. market towards screen-free entertainment, an area in which current digital content devices have previously found success but must now adapt to remain competitive. Thus, there is a need for innovative audio solutions that combine portability with flexible content access to meet the evolving preferences of consumers.

Some similar devices exist in the art. However, their means of operation are substantially different from the present disclosure, as the other inventions fail to solve all the problems taught by the present disclosure.

### SUMMARY

The present invention and its embodiments relate to a system, a method, and an apparatus for the secure management of the supply of digital content to a device worn on a body of a user, the device utilizing an object in association with the device in such a manner as to enhance the experience of the device content playback, while addressing commercial concerns of digital content distribution and copyright.

A first embodiment of the present invention describes a system. The system includes a cloud backend, a cloud web portal, an object, and a wearable device configured to be worn by a user. The wearable device includes a receiving portion configured to detect receipt of the object and one or more speakers. The wearable device may comprise headphones, a virtual reality (VR) headset, an augmented reality headset, or a mixed reality headset, among other wearable devices not explicitly described herein.

In a first example, the object comprises a first set of magnets and a radio frequency identification (RFID) passive tag. In this example, the receiving portion of the wearable device comprises a second set of magnets, an active RFID reader, and a Hall sensor. When the object is received by the receiving portion of the wearable device, the first set of magnets engages the second set of magnets via a magnetic connection to affix the object to the receiving portion of the wearable device. Moreover, when the object is received by the receiving portion of the wearable device, the first set of magnets of the object activates the Hall sensor of the wearable device. In turn, the Hall sensor activates a read cycle of the active RFID reader in the receiving portion of the wearable device. Moreover, activation of the read cycle of the active RFID reader of the receiving portion of the wearable device comprises detection of an identifier and a security code associated with digital content from the RFID passive tag of the object.

In some examples, the object is received by and affixed to the receiving portion of the wearable device via a mechanical means. In a further example, the receiving portion of the wearable device comprises a light sensor comprising a photodiode and an optical sensory array comprising one or more photo-elements. In response to the object being received by the receiving portion of the wearable device, the light sensor of the receiving portion of the wearable device is covered by the object to activate a handshake to detect an identifier and a security code associated with digital content of the object.

In an additional example, the object comprises electronic circuitry and a means to store an identifier and a security code associated with digital content. In response to the object being received by the receiving portion of the wearable device, a circuit in the wearable device is closed, allowing an identifier and a security code associated with digital content to be transferred to the wearable device.

In a further example, each of the wearable device and the object comprises an electronic circuit. When the object is received by the receiving portion of the wearable device, an identifier and a security code associated with digital content are transferred to the wearable device.

In another example, a user utilizes an application executable on a computing device to create a user account via the cloud web portal. The cloud backend is configured to: verify that the wearable device is associated with the user account and confirm a purchase of digital content of the object.

A second embodiment of the present invention describes a system. The system includes an object, a wearable device, a cloud web portal, and a cloud backend. The wearable device is configured to be worn by a user. The wearable device includes a receiving portion configured to detect receipt of the object and one or more speakers. The cloud web portal is configured to receive account information associated with a user. The cloud backend is configured to verify that the wearable device is associated with the user account and confirm a purchase of digital content of the object.

In some examples, the object includes a first set of magnets and an RFID passive tag. The receiving portion of the wearable device comprises a second set of magnets, an active RFID reader, and a Hall sensor. When the object is received by the receiving portion of the wearable device, the first set of magnets engages the second set of magnets via a magnetic connection to affix the object to the receiving portion of the wearable device. In some examples, when the object is received by the receiving portion of the wearable device, the first set of magnets of the object activates the Hall sensor of the wearable device. Moreover, the Hall sensor activates a read cycle of the active RFID reader in the receiving portion of the wearable device. Additionally, activation of the read cycle of the active RFID reader of the receiving portion of the wearable device comprises detection of an identifier and a security code associated with digital content from the RFID passive tag of the object.

In other examples, the receiving portion of the wearable device comprises: a light sensor comprising a photodiode, and an optical sensory array comprising one or more photo-elements. In response to the object being received by the receiving portion of the wearable device, the light sensor of the receiving portion of the wearable device is covered by the object to activate a handshake to detect an identifier and a security code associated with digital content of the object.

A third embodiment of the present invention describes a method for downloading content into a wearable device. The method includes numerous process steps, such as: utilizing an application executable on a computing device to create a user account via a web portal, affixing an object to a receiving portion of a wearable device, detecting the object by the receiving portion of the wearable device, reading tag data of the object, verifying that the wearable device is associated with the user account, confirming a purchase of the digital content of the object, and utilizing the tag data to interact with a cloud backend to download the digital content.

It should be appreciated that in the embodiments disclosed herein, a wired, wireless, and/or a touch connection method or technology may be used. Example wireless connection methods include a Bluetooth connection, a radio broadcast connection, a mesh system, an Ultra-wideband (UWB) connection or a Wi-Fi connection, among others not explicitly described herein. Furthermore, touch connection mechanisms or methods include galvanic or capacitive coupling methods that occur by skin contact or another mechanism. Additionally, one or more connection methods or means described herein may operate simultaneously.

In general, the present invention succeeds in conferring the following benefits and objectives.

It is an object of the present invention to provide a wearable device that may download digital content from a server or other source, and store and playback digital content or stream digital content from the server.

It is an object of the present invention to provide a child-friendly wearable device.

It is an object of the present invention to provide a child-friendly system for the secure management of the supply of digital content, including copyrighted content, to a wearable device.

The advent of children's audio content consumption has increasingly shifted towards portable and personalized solutions, driven by the need to provide an engaging and immersive experience while mitigating external distractions. Traditional stationary speakers have faced challenges in maintaining user engagement due to their susceptibility to environmental noise and interruptions. Market research indicates that approximately one in three consumers of some of these products subsequently invest in headphones to enhance their auditory experience, underscoring a gap in the existing product offerings. Addressing this need, smart headphones have been developed as a solution for personal audio consumption. These smart headphones are configured to deliver a high-quality, immersive audio experience tailored for a user such as a child to substantially decrease external disturbances and provide an interface for accessing digital content. By integrating advanced technology and user-friendly features, smart headphones represent an advancement in the realm of children's audio devices, ensuring a focused and enjoyable listening environment.

In an embodiment, the smart headphones provide a screen-free audio content experience for users both at home and on the go, eliminating the need for additional hardware purchases by directly accessing a digital content library through a new app interface. This system features a display configured for a data link process employed by the headphones, allowing for content control.

In some aspects, the techniques described herein relate to a system, including: a security code assigned to a device; a control system including: a graphical user interface (GUI); a user authentication system, including: a user account in communication with the security code of the device to authenticate the user account; a digital content management system including: a database of encrypted digital content, the encrypted digital content is associated with an identifier; a digital token assigned to the user account, the digital token to validate access to the encrypted digital content of the device, based on the identifier of the encrypted digital content; a processor coupled to a power source; and a memory, coupled to the processor to store executable instructions, the executable instructions to: validate the user account; responsive to validation of access to the encrypted digital content of the device, via the digital token, decrypt and decode the encrypted digital content for output of the encrypted digital content to the authenticated user account; and download and store the decrypted digital content to the memory responsive to when the user account is authenticated.

In some aspects, the techniques described herein relate to a system, wherein the device has a rotatable bezel and a rotary encoder coupled to the rotatable bezel, the rotatable bezel has a substantially central opening, the GUI is located in the substantially central opening of the rotatable bezel.

In some aspects, the techniques described herein relate to a system, wherein the rotatable bezel has one or more protrusion structures configured to be gripped by a user during rotation of the rotatable bezel.

In some aspects, the techniques described herein relate to a system, further including an audio system.

In some aspects, the techniques described herein relate to a system, wherein the audio system is a near-ear audio system.

In some aspects, the techniques described herein relate to a system, wherein a light emitting unit implementing the audio system.

In some aspects, the techniques described herein relate to a set 1, wherein the set of headphones including: a headband; a first ear cup connected to a first end of the headband; a second ear cup connected to a second end of the headband; the GUI disposed at the first ear cup; a rotatable bezel connected to the first ear cup; a first ear pad connected to the first ear cup; and a second ear pad connected to the second ear cup.

In some aspects, the techniques described herein relate to a system, wherein the headband further including: a capacity-wearing detector configured to power off the GUI when the set of headphones are worn on a user's head, and to illuminate the GUI when the set of headphones are removed.

In some aspects, the techniques described herein relate to a system, wherein the headband further including: one or more sensors in communication with the processor.

In some aspects, the techniques described herein relate to a system, wherein the one or more sensors, including at least one accelerometer, gyroscope, or inertial measurement unit (IMU), configured to detect one or more user body movements and transmit the one or more user body movements to the processor to activate a modification in interactive storytelling.

In some aspects, the techniques described herein relate to a system, wherein the digital content management system, including: an object; an NFC tag located at the object, the NFC tag with one or more encrypted data links associated with the digital content; and a remote NFC reader, the NFC tag to transmit the one or more encrypted data links to the remote NFC reader when the object is located within a predetermined proximity to the remote NFC reader.

In some aspects, the techniques described herein relate to a system, wherein the digital content management system, including: an electronic display device; a graphic user interface (GUI) accessible via the electronic display device; and an application platform to operate through the GUI, the application platform with one or more encrypted data links associated with the digital content of the digital content management system.

In some aspects, the techniques described herein relate to an near-ear audio system, including: a set of headphones, including: a headband; a first ear cup connected to a first end of the headband; a second ear cup connected to a second end of the headband; and a control system including: a graphical user interface (GUI) disposed at the first ear cup; a rotatable bezel connected to the first ear cup; and a rotary encoder coupled to the rotatable bezel; and a digital content management system including: a database of digital content; a user authentication system; a processor coupled to a power source; and a memory, coupled to the processor to store executable instructions, the executable instructions to: instructions to validate a user; instructions to download and store the digital content to the memory responsive to when the user is authenticated; and instructions to decrypt and decode the digital content for output of the digital content, via the near-ear audio system, to an authenticated user.

In some aspects, the techniques described herein relate to a near-ear audio system, wherein the rotatable bezel has a substantially central opening, the GUI is located in the substantially central opening of the rotatable bezel.

In some aspects, the techniques described herein relate to a near-ear audio system, wherein the rotatable bezel has one or more protrusion structures configured to be gripped by the user during rotation of the rotatable bezel.

In some aspects, the techniques described herein relate to a near-ear audio system, further including: a security code assigned to the set of headphones; a user authentication system including: a user account in communication with the security code of the set of headphones to authenticate the user account; a digital content management system including: a database of digital content, the digital content is associated with an identifier; and a digital token assigned to the user account, the digital token to validate access to the digital content of the set of headphones, based on the identifier of the digital content; the executable instructions further to: validate the user account; download and store the digital content to the memory responsive to when the user account is authenticated; and responsive to validation of access to the digital content of the set of headphones, via the digital token, decrypt and decode the digital content for output of the digital content to the authenticated user account when the digital token.

In some aspects, the techniques described herein relate to a near-ear audio system, wherein the set of headphones further including: one or more sensors in communication with the processor.

In some aspects, the techniques described herein relate to a device, including: an audio system; a security code assigned to the device; a control system including: a graphical user interface (GUI); a user authentication system including: a user account in communication with the security code of the device to authenticate the user account; a digital content management system including: a database of digital content, the digital content is associated with an identifier; and a digital token assigned to the user account, the digital token to validate access to the digital content of the device, based on the identifier of the digital content; a processor coupled to a power source; and a memory, coupled to the processor to store executable instructions, the executable instructions to: validate the user account; download and store the digital content to the memory responsive to when the user account is authenticated; and responsive to validation of access to the digital content of the device, via the digital token, decrypt and decode the digital content for output of the digital content, via the audio system, to the authenticated user account when the digital token.

In some aspects, the techniques described herein relate to a device, wherein the digital content management system, including: an object; an NFC tag located at the object, the NFC tag with one or more encrypted data links associated with at least the digital content; and a remote NFC reader, the NFC tag to transmit the one or more encrypted data links to the remote NFC reader when the object is located within a predetermined proximity to the remote NFC reader.

In some aspects, the techniques described herein relate to a device, wherein the digital content management system, including: an electronic display device; a graphic user interface (GUI) accessible via the electronic display device; and an application platform to operate through the GUI, the application platform with one or more encrypted data links associated with the digital content of the digital content management system.

In some aspects, the techniques described herein relate to a device, wherein the NFC tag is configured to initiate connection between the device to one or more local networks of one or more devices.

In some aspects, the techniques described herein relate to a device, wherein the NFC tag is configured to allows multiplayer and multidevice features to be activated.

In some aspects, the techniques described herein relate to a device, wherein the NFC tag is configured to delete at least a portion of data retained on the device.

In some aspects, the techniques described herein relate to a device, wherein the digital content management system, including: an electronic display device; a GUI is accessible via the electronic display device; and an application platform to operate through the GUI, the application platform with one or more encrypted data links associated with the digital content of the digital content management system.

It is to be understood that the foregoing general description and the following detailed description are exemplary and explanatory but not limiting, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate disclosed embodiments and/or aspects and, together with the description, serve to explain the principles of the invention, the scope of which is determined by the claims.

FIG. 1 depicts a block diagram of cloud solution architecture of a system, according to at least some embodiments disclosed herein.

FIG. 2 depicts a block diagram of a method executed by a cloud backend of a system according to at least some embodiments disclosed herein.

FIG. 3 depicts a block diagram of cloud solution architecture of a system, according to at least some embodiments disclosed herein.

FIG. 4 depicts a perspective view of a schematic diagram depicting an object being affixed to a receiving portion of a wearable device, according to at least some embodiments disclosed herein.

FIG. 5 depicts a perspective view of a schematic diagram depicting rotation of an object in a receiving portion of a wearable device, according to at least some embodiments disclosed herein.

FIG. 6 depicts a perspective view of a schematic diagram of an object affixed to a receiving portion of a wearable device, according to at least some embodiments disclosed herein.

FIG. 7 depicts a perspective view of a schematic diagram of an object affixed to a receiving portion of a wearable device, the object having a timer mechanism, according to at least some embodiments disclosed herein.

FIG. 8 depicts a perspective view of a schematic diagram of an object affixed to a receiving portion of a wearable device, the object having a timer mechanism, according to at least some embodiments disclosed herein.

FIG. 9 depicts a perspective view of a schematic diagram depicting an object being affixed to a receiving portion of a wearable device, according to at least some embodiments disclosed herein.

FIG. 10 depicts a perspective view of a schematic diagram depicting a wand object interacting with a disk object affixed to a receiving portion of a wearable device, according to at least some embodiments disclosed herein.

FIG. 11 depicts a perspective view of a schematic diagram depicting a figurine object interacting with a disk object affixed to a receiving portion of a wearable device, according to at least some embodiments disclosed herein.

FIG. 12 depicts a perspective view of a schematic diagram depicting a figurine object interacting with a disk object affixed to a receiving portion of a wearable device, according to at least some embodiments disclosed herein.

FIG. 13 depicts a perspective view of a schematic diagram depicting an optical sensor array and a light sensor of an object affixed to a receiving portion of a wearable device, according to at least some embodiments disclosed herein.

FIG. 14 depicts a perspective view of a schematic diagram depicting a Hall sensor and an optical sensor array of an object affixed to a receiving portion of a wearable device, according to at least some embodiments disclosed herein.

FIG. 15 depicts a perspective view of a schematic diagram depicting a transmitter and a battery of an object, according to at least some embodiments disclosed herein.

FIG. 16 depicts a perspective view of a schematic diagram depicting an antenna, a smart chip, and an optical mark of an object, according to at least some embodiments disclosed herein.

FIG. 17 depicts a perspective view of a schematic diagram of a wearable device, a ferrous magnetic cup, and a permanent magnet, according to at least some embodiments disclosed herein.

FIG. 18 depicts a perspective view of a schematic diagram of an object, a ferrous magnetic cup, and a permanent magnet, according to at least some embodiments disclosed herein.

FIG. 19 depicts a perspective view of a schematic diagram of a magnetic force-based method for attaching and positioning an object to a wearable device, according to at least some embodiments disclosed herein.

FIG. 20 depicts a perspective view of a schematic diagram of a magnetic force-based method for attaching and positioning an object to a wearable device, according to at least some embodiments disclosed herein.

FIG. 21 depicts a perspective view of a schematic diagram of a magnetic force-based method for attaching and positioning an object to a wearable device, according to at least some embodiments disclosed herein.

FIG. 22 depicts a perspective view of a schematic diagram of a position detection method used for affixing an object to a wearable device, according to at least some embodiments disclosed herein.

FIG. 23 depicts a perspective view of a schematic diagram of a position detection method used for affixing an object to a wearable device, according to at least some embodiments disclosed herein.

FIG. 24 depicts a perspective view of a schematic diagram of a position detection method used for affixing an object to a wearable device, according to at least some embodiments disclosed herein.

FIG. 25 depicts a perspective view of a schematic diagram of a position detection method used for affixing an object to a wearable device, according to at least some embodiments disclosed herein.

FIG. 26 depicts a perspective view of a schematic diagram of a position detection method used for affixing an object to a wearable device, according to at least some embodiments disclosed herein.

FIG. 27 depicts a perspective view of a schematic diagram of interactive story context indexing, according to at least some embodiments disclosed herein.

FIG. 28 depicts a perspective view of a schematic diagram of interactive story context indexing, according to at least some embodiments disclosed herein.

FIG. 29 depicts a perspective view of a schematic diagram of interactive story context indexing, according to at least some embodiments disclosed herein.

FIG. 30 depicts a perspective view of a schematic diagram of interactive story context indexing, according to at least some embodiments disclosed herein.

FIG. 31 depicts a perspective view of a schematic diagram of interactive story context indexing, according to at least some embodiments disclosed herein.

FIG. 32 depicts a perspective view of a schematic diagram of a first example of two or more users interacting with digital content via a connection to a wearable device (e.g., smart glasses), according to at least some embodiments disclosed herein.

FIG. 33 depicts a perspective view of a schematic diagram of a first example of two or more users interacting with digital content via a connection to a wearable device (e.g., smart glasses), according to at least some embodiments disclosed herein.

FIG. 34 depicts a perspective view of a schematic diagram of a second example of two or more users interacting with digital content via a connection to a wearable device (e.g., headphones), according to at least some embodiments disclosed herein.

FIG. 35 depicts a perspective view of a schematic diagram of a second example of two or more users interacting with digital content via a connection to a wearable device (e.g., headphones), according to at least some embodiments disclosed herein.

FIG. 36 depicts a perspective view of a schematic diagram of an ancillary device worn by a user, according to at least some embodiments disclosed herein.

FIG. 37 depicts a perspective view of a schematic diagram of an ancillary device coming into contact with a wearable device of a user, according to at least some embodiments disclosed herein.

FIG. 38 depicts a perspective view of a schematic diagram of a hand gesture or movement occurring while a user is wearing an ancillary device, according to at least some embodiments disclosed herein.

FIG. 39 depicts a perspective view of a schematic diagram of a handshake that occurs between a first ancillary device worn by a first user and a second ancillary deice worn by a second user, according to at least some embodiments disclosed herein.

FIG. 40 depicts a perspective view of a schematic diagram of a head nodding movement occurring while a user is wearing a wearable device, according to at least some embodiments disclosed herein.

FIG. 41 depicts a perspective view of a schematic diagram of a user wearing a wearable device that comprises one or more proximity sensors, according to at least some embodiments disclosed herein.

FIG. 42 depicts a perspective view of a schematic diagram of a user utilizing spatial positioning technology, according to at least some embodiments disclosed herein.

FIG. 43 depicts a perspective view of a schematic diagram of two users utilizing spatial positioning technology, according to at least some embodiments disclosed herein.

FIG. 44 illustrates a configuration in which multiple parties form a network and communicate with each other.

FIG. 45 illustrates a user wearing a virtual reality (VR) or enhanced reality (ER) headset.

FIG. 46 shows two sets of headphones configured to communicate wirelessly with the other when brought into close proximity to each other

FIG. 47 shows three sets of headphones interacting with an object, in this embodiment depicted for illustrative purposes as a wand. The object may be configured to allow any or all of the headphones or other appropriately configured devices, when the object is brought into close proximity with the them, to obtain digital content, or to be authorized to form a local area network (LAN) together, or to receive an index decision node input provided by the object, or to authorize the headphone(s) to enable or activate functions or features of the device, or to store digital content on the device authorized to activate.

FIG. 48 illustrates an example embodiment of an index system.

FIG. 49 shows a simple implementation of an indexing system.

FIG. 50 shows various inputs including a content element just completed, or gesture inputs, or other inputs from the user.

FIG. 51 shows a logic network in which multiple inputs are used to produce an output selection.

FIG. 52 illustrates an example in which a particular content element ends by giving the user a choice of options.

FIG. 53 illustrates the object in the form of wand being used to active content elements in the device where the content elements are game related.

FIG. 54 illustrates the object in the form of wand being used to activate content elements in the device where the content elements are educational related.

FIG. 55 illustrates a peripheral device with an RFID tag being brought into proximity to a device such that the device recognizes and authorizes the use of the peripheral in the system where the peripheral is a bracelet.

FIG. 56 illustrates a peripheral device with an RFID tag being brought into proximity to a device such that the device recognizes and authorizes the use of the peripheral in the system where the peripheral is a game controller.

FIG. 57 illustrates a device in the form of a virtual reality headset having digital content uploaded into an index at the factory level.

FIG. 58 illustrates a device in the form of a headphone having digital content uploaded in an index at the factory level

FIG. 59 illustrates a device interacting with a cloud platform with the user interface hosted on the device

FIG. 60 illustrates a device interacting with a cloud platform via an app or web browser running on an independent device such as a phone or PC.

FIG. 61 illustrates a front plan view of an example of a set of headphones implementing a near-ear audio system in accordance with some embodiments.

FIG. 62 illustrates a right side perspective view of the set of headphones of FIG. 61 employing a control system with a GUI and rotating bezel in accordance with some embodiments.

FIG. 63 illustrates a left side perspective view of the set of headphones of FIG. 61 employing a control system with a near field communication (NFC) reader and one or more light emitting diodes (LEDs) in accordance with some embodiments.

FIG. 64 illustrates a right rear perspective view of the set of headphones of FIG. 61 employing the GUI and the rotating bezel of FIG. 62 in accordance with some embodiments.

FIG. 65 illustrates a left perspective view of the set of headphones of FIG. 61 employing a control system with a near field communication (NFC) reader and one or more light emitting diodes (LEDs) in accordance with some embodiments.

FIG. 66 illustrates a right perspective view of the set of headphones of FIG. 61 employing the control system with the GUI and the rotating bezel of FIGS. 62 and 64 in accordance with some embodiments.

FIG. 67 illustrates a rear perspective view of the set of headphones of FIG. 61 employing a hingedly pivotable folding mechanism oriented in an open configuration accordance with some embodiments.

FIG. 68 illustrates a perspective view of an NFC tag implemented at an object that is magnetically coupled via electromagnetic induction with the set of headphones of FIG. 61 in accordance with some embodiments.

FIG. 69 illustrates a diagram illustrating the set of headphones of FIG. 61 employing a data link to a cloud storage location where a digital content file is stored in accordance with some embodiments.

FIG. 70 illustrates a diagram illustrating a process of device authentication employed by the set of headphones of FIG. 61 in accordance with some embodiments.

FIG. 71 illustrates a diagram illustrating a process of content download employed by the set of headphones of FIG. 61 in accordance with some embodiments.

FIG. 72 illustrates a diagram of a system controller implemented in the headphones of FIG. 61, having a wireless subsystem, an audio subsystem, a display subsystem, memory, and a power source in accordance with some embodiments.

### DETAILED DESCRIPTION

Example embodiments of the present invention will now be described with reference to the drawings, in which identical elements are identified with the same reference numerals. These embodiments are provided by way of explanation of the present invention, which is not intended to be limited thereto. In fact, those of ordinary skill in the art may appreciate upon reading the present specification and viewing the present drawings that various modifications and variations may be made thereto.

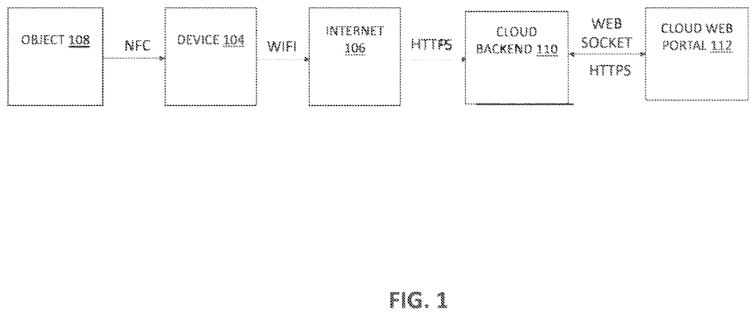

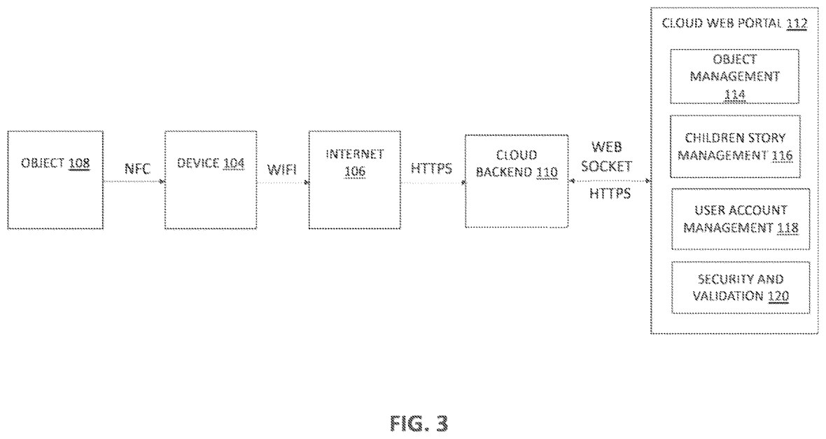

FIG. 1 and FIG. 3 depict block diagrams of cloud solution architecture of a system. As shown in FIG. 1, the system includes an object 108, a wearable device 104, Internet 106, a cloud backend 110, and a cloud web portal 112. The object 108 includes, but is not limited to, an item or component that is designed in a manner to enhance the commercial or educational appeal of the wearable device 104. The object 108 can be whatever size or shape. In some examples, the object 108 may click or snap on top of the wearable device 104 (e.g., the headphones), and in other examples, the object 108 may not. The object 108 may include text and/or graphics (of cartoon characters, collegiate mascots, professional sports team mascots, etc.). Such text and/or graphics may demonstrate the nature of the digital content stored on the object 108. For example, the text “Goldilocks and the Three Bears” accompanied by a graphic of showing a child and three bears would demonstrate that the digital content stored on the object 108 may be the audiobook associated with the fairytale Goldilocks and the Three Bears. In another example, the graphic of a cartoon character on the object 108 may demonstrate that the digital content stored on the object 108 may be audio and/or visual content associated with a television show containing the cartoon character. In all exemplary embodiments of the object 108 provided herein, a mixture of mechanical, magnetic, optical, and/or or circuitry may be used to aid security, cost of production, or reliability of functionality.

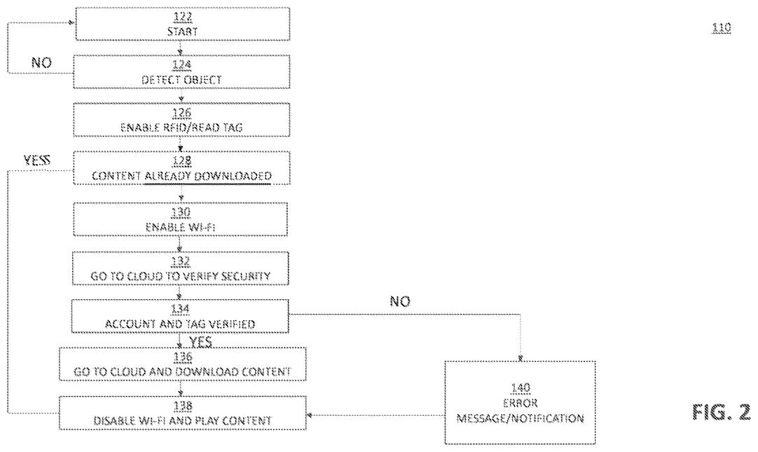

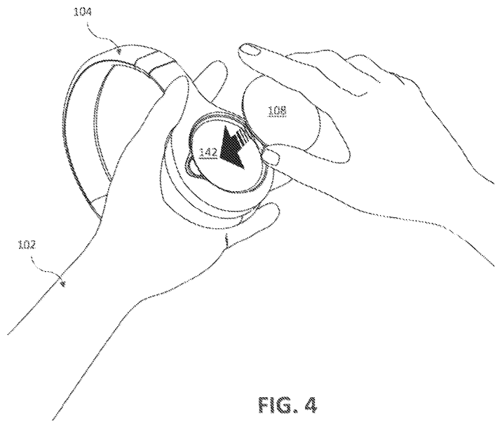

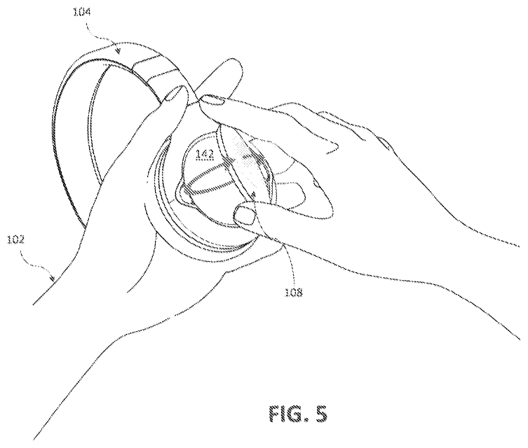

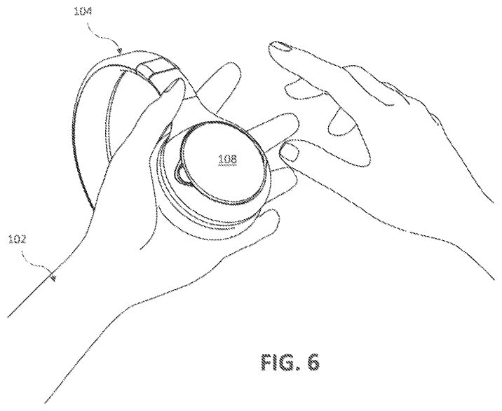

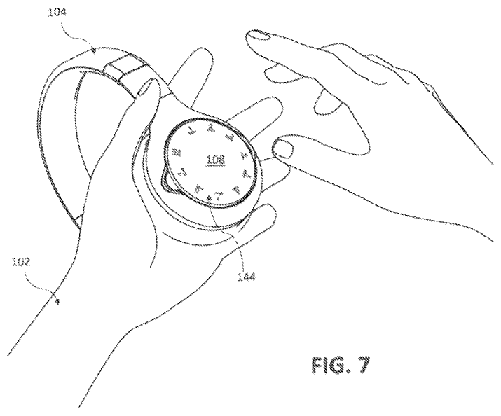

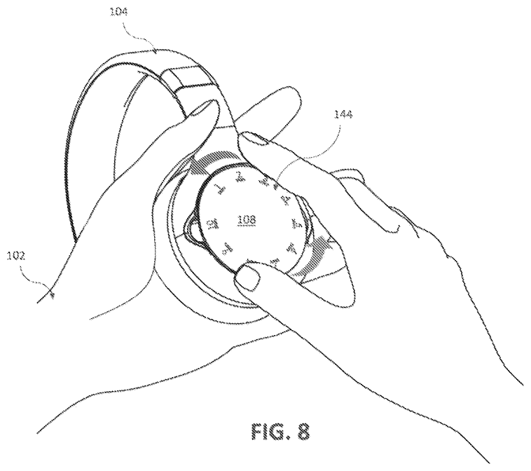

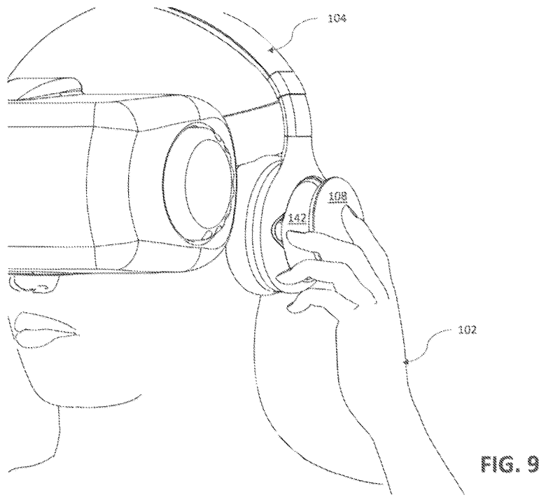

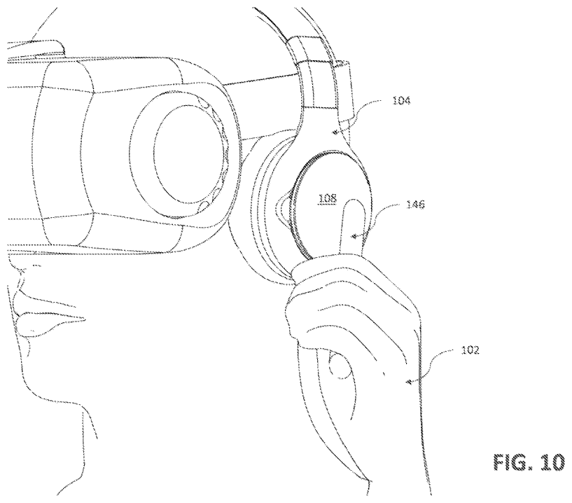

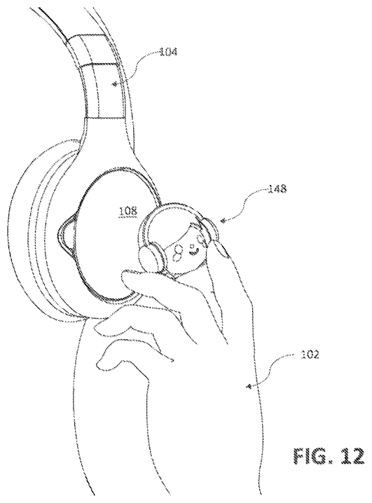

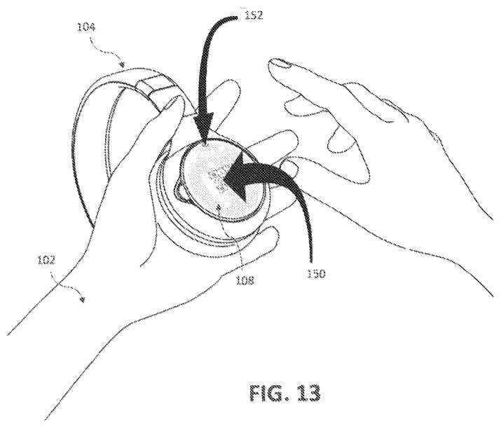

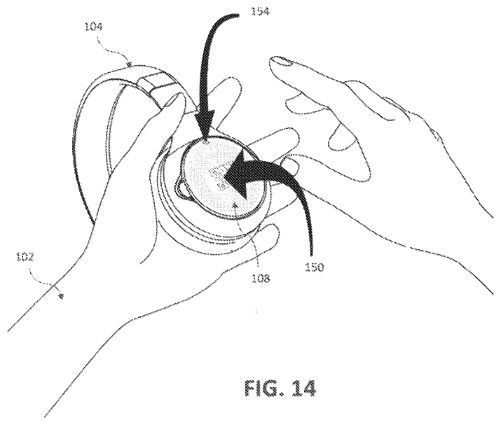

A user 102 (of FIG. 4, FIG. 5, FIG. 6, FIG. 7, FIG. 8, FIG. 9, FIG. 10, FIG. 12, FIG. 13, and FIG. 14) may utilize an application executable on a computing device to engage a cloud web portal 112 (of FIG. 1 and FIG. 3) to create and sign into a user account in the cloud backend 110 (of FIG. 1, FIG. 2, and FIG. 3). In some examples, such interaction may occur via a wireless communication method through the Internet 106 (of FIG. 1 and FIG. 3). Creation of such user account occurs prior to purchase and use of the object 108. The user 102 may also interact with one or more components of the cloud web portal 112, such as an object management component 114, a content management component 116, a user account management component 118, and/or a security and validation component 120, as shown in FIG. 3.

The object 108 may then interface with a receiving portion 142 (of FIG. 4, FIG. 5, and FIG. 9) of the wearable device 104 using near field communication (NFC), which will be elaborated on herein. The object 108 is received by and affixed to the receiving portion 142 of the wearable device 104 via a mechanical means or a magnetic means, among other means not explicitly described herein. The receiving portion 142 of the wearable device 104 also includes one or more speakers. In embodiments, multiple objects can be received and affixed to the device, as will be described.

Tag data of the object 108 is read and used to interact with the cloud backend 110 to download digital content (e.g., audio and/or visual content) or directly stream the digital content. The audio and/or the visual content may be associated with podcasts, audiobooks, music, plays, television shows, movies, etc., and is not limited to any specific audio and/or visual content. In an illustrative example, the digital content may be audio content for a children's book (e.g., an audiobook), such as Goldilocks and the Three Bears. The digital content may be associated with a first identifier and a first security code.

A second digital content may be audio content for a scientific podcast. The second digital content may be associated with a second identifier and a second security code. The first security code and the second security code are used for the secure management of the first digital content and the second digital content, respectively. In some examples, the first digital content and the second digital content may additionally include other cryptology mechanisms, not explicitly listed herein, to assist in the secure management of the first digital content and the second digital content.

Moreover, it is determined if the wearable device 104 is associated with the user account and if the digital content was purchased in the cloud backend 110 by the user 102 prior to downloading or streaming the digital content.

FIG. 2 depicts a block diagram of a method executed by the cloud backend 110 of the system of FIG. 1 or FIG. 3. A process step 122 begins the method of FIG. 2. A process step 124 follows the process step 122 and includes the receiving portion 142 of the wearable device 104 detecting the object 108. A process step 126 follows the process step 124. In the process step 126, the receiving portion 142 of the wearable device 104 comprises an active RFID reader and the object 108 comprises an RFID passive tag. In the process step 126, the RFID reader reads the RFID passive tag of the object 108.

A process step 128 follows the process step 126 and includes determining if content was already downloaded to the object 108. If the response to the process step 128 is “YES,” the method moves onto a process step 138 that includes disabling a wireless communication method of the system and playing the digital content to the user 102 via one or more speakers of the wearable device 104. If the response to the process step 128 is “NO,” the method moves on to a process step 130 to enable the wireless communication method of the system.

A process step 132 follows the process step 130 and includes verifying security of the digital content via the cloud. A process step 134 follows the process step 132 and includes determining if the user account and the RFID passive tag of the object 108 are verified. If the response to the process step 134 is “YES,” the method moves onto a process step 136 that includes downloading content from the cloud. If the response to the process step 134 is “NO,” the method moves to a process step 140, which includes producing an error message or notification for the user 102.

The wearable device 104 described herein is configured to be worn by the user 102. In a first illustrative example, and as depicted in FIG. 4, FIG. 5, FIG. 6, FIG. 7, FIG. 8, FIG. 13, and FIG. 14, the wearable device 104 comprises headphones 104. In this first example, the digital content comprises the audio content. In a second illustrative example, and as depicted in FIG. 9 and FIG. 10, the wearable device 104 comprises a virtual reality (VR) headset. In this second illustrative example, the digital content comprises the audio content and the visual content such that the visual content may be displayed in two-dimensions or three-dimensions to the user 102 via a display of the VR headset and the user 102 may listen to the audio content via the headphones associated with the VR headset. It should be appreciated that the wearable device 104 is not limited to such examples, as such examples are provided for illustrative purposes only. In some examples, the wearable device may comprise an augmented reality headset, or a mixed reality headset, among other wearable devices not explicitly described herein. In some examples, tactile effects are used while or subsequent to playing the audio and/or the visual content on the wearable device 104.

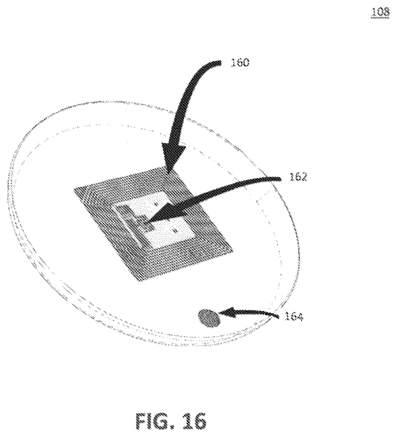

It should be appreciated that the object 108 may be affixed to the receiving portion 142 of the wearable device 104 via a mechanical means or a magnetic means, among other means not explicitly described herein. In a first example, the object 108 comprises a first set of magnets and the RFID passive tag. The RFID passive tag may include a smart chip 162, a printed antenna 160, and an optical mark 164 of FIG. 16. The printed antenna 160 may be used for WLAN, a mobile data radio technology, or a connection socket for connecting a cable of a local network that also has Internet access (e.g., a connection socket for an Ethernet cable).

In this first embodiment, the receiving portion 142 of the wearable device 104 comprises: a second set of magnets, the active RFID reader, and a Hall sensor 154. A quantity of the magnets in the first set of magnets and the second set of magnets is not limited to any particular quantity. Further, in some examples, the first set of magnets and the second set of magnets may be a magnetic portion or component.

As described herein, a “Hall sensor” or a “Hall effect sensor” is a device that is used to measure the magnitude of a magnetic field. The output voltage of the Hall sensor 154 is directly proportional to the magnetic field strength through it. Hall Effect sensors are used for proximity sensing, positioning, speed detection, and sensing applications.

When the object 108 is received by the receiving portion 142 of the wearable device 104, the first set of magnets of the object 108 is in a magnetic connection with the second set of magnets of the receiving portion 142 of the wearable device 104 to affix the object 108 to the receiving portion 142 of the wearable device 104. Moreover, when the object 108 is received by the receiving portion 142 of the wearable device 104, the first set of magnets of the object 108 activates the Hall sensor 154 of the wearable device 104. In turn, the Hall sensor 154 activates a read cycle of the active RFID reader in the receiving portion 142 of the wearable device 104. The activation of the read cycle of the active RFID reader of the receiving portion 142 of the wearable device 104 comprises detection of the identifier associated with the digital content and the security code associated with the digital content from the RFID passive tag of the object 108.

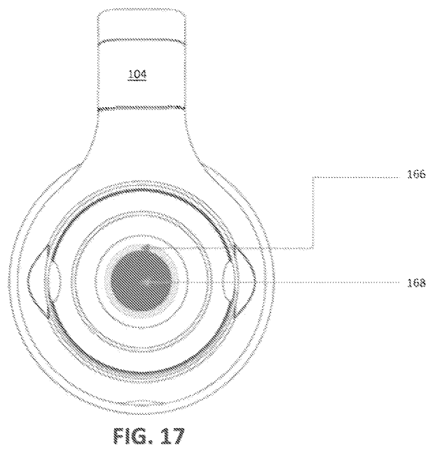

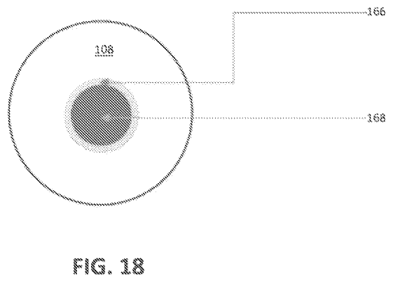

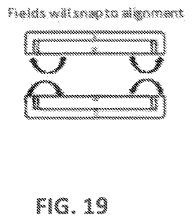

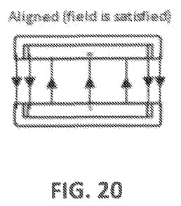

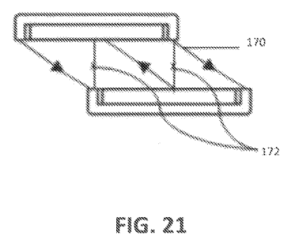

In a further example, and as depicted in FIG. 17, FIG. 18, FIG. 19, FIG. 20, and FIG. 21, a magnetic force-based method may be used for attaching and positioning the object 108 within the receiving portion 142 of the wearable device 104. A ferrous metal cup 166 and a permanent magnet 168 are depicted in FIG. 17 and FIG. 18. In order to achieve robust and accurate locating of the object 108, an aligning magnetic field structure is used. As shown in FIG. 19, FIG. 20, and FIG. 21, field alignment forces the object 108 to a location in an axial position such that misalignment is not possible, as repulsive forces are generated when the fields are misaligned, thereby laterally pushing the object 108 into a central position. Such misalignment is further depicted in FIG. 21, where the misaligned fields 172 pull closer 170, with a net force pushing towards repulsion. Moreover, the magnetic field described herein is concentrated by use of the ferrous metal cup 166 that shapes the magnetic field lines. The ferrous metal cup 166 provides a degree of shielding against stray magnet fields.

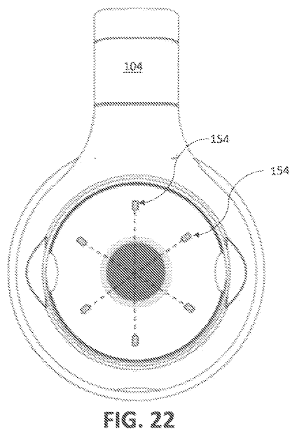

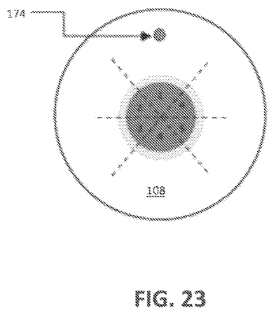

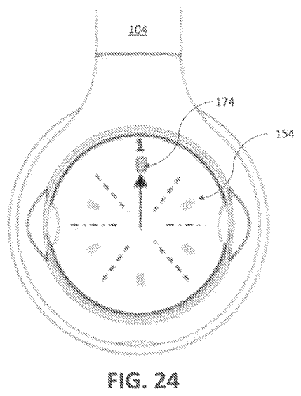

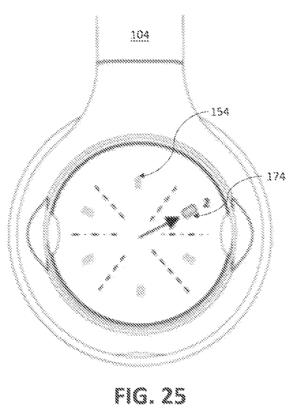

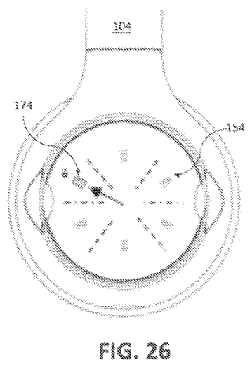

Furthermore, in referencing FIG. 22, FIG. 23, FIG. 24, FIG. 25, and FIG. 26, the object 108 contains an RFID tag that uniquely identifies the object 108 and is mapped to specific content. The use of a unique RFID tag abstracts the content from the object 108, thereby allowing any object 108 to be associated with any content or content collection. In order for the RFID tag to be read, it must be in close proximity to the RFID reader located in the wearable device 104 (e.g., the headphones). In addition, a trigger event is required to indicate to the system to attempt to read the RFID tag. In examples described herein, the trigger event is generated by one or more Hall sensors 154 (of FIG. 22, FIG. 24, FIG. 25, and FIG. 26), which produces a digital output when subject to the magnetic field.

The magnetic field comes from a permanent magnet 174 (of FIG. 23, FIG. 24, FIG. 25, and FIG. 26) located inside of the object 108. Moreover, in examples, the object 108 comprises the multiple Hall sensors 154 in a circular pattern to allow the rotational position of the object 108 to be detected in an absolute fashion. The circular-shaped pattern is provided for illustrative purposes only and other shaped patterns are contemplated herein. Further, as shown in FIG. 24, FIG. 25, and FIG. 26, the object 108 may index or trigger multiple sets of content based on the rotational position of the object 108 in relation to the wearable device 104 (e.g., a first position of FIG. 24, a second position of FIG. 25, and a sixth position of FIG. 26, among others not explicitly listed herein).

In another embodiment, a printed barcode may be present on the object 108. The receiving portion 142 of the wearable device 104 comprises a light sensor comprising a photodiode. The receiving portion 142 of the wearable device 104 also includes an optical sensory array 150 (of FIG. 13). The optical sensor array 150 comprises one or more photo-elements, such as photodiodes or transistors arranged in an N×N matrix configuration. In response to the object 108 being received by the receiving portion 142 of the wearable device 104, the light sensor of the receiving portion 142 of the wearable device 104 is covered by the object 108 to trigger a handshake to detect the identifier associated with the digital content and the security code associated with the digital content of the object 108.

In a further embodiment, and as depicted in FIG. 13, the object 108 comprises electronic circuitry 152 and a means to store the identifier and the security code. Such storage may include the memory or the storage component. In this embodiment, the receiving portion 142 also includes the electronic circuitry 152. In response to the object 108 being received by the receiving portion 142 of the wearable device 104, a circuit in the wearable device 104 is closed, allowing the identifier associated with the digital content and the security code to be transferred to the wearable device 104.

In some examples of this embodiment, the wearable device 104 may comprise a microphone or a plurality of microphones. The microphone or the plurality of microphones may comprise voice recognition software. The voice recognition software may be configured to receive and analyze voice commands from the user 102 to manage the digital content. In other examples, the microphone or plurality of microphones may be used for noise cancelation, echo cancellation, voice intelligibility and other acoustic functions.

Moreover, in examples, the microphone or plurality of microphones may be used to assist in a detection of an angle of arrival of an acoustic wave. The wearable device 104 may contain an antenna, or a plurality of antennae, to be used for a beamforming function as used in detection of the angle of arrival of a radio wave.

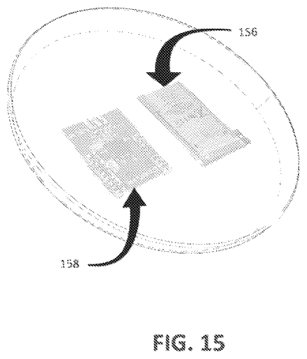

In another embodiment, and as depicted in FIG. 15, the receiving portion 142 of the wearable device 104 comprises an electronic receiver 158. Further, the object 108 comprises an electronic transmitter and a battery 156. In this embodiment, when the object 108 is received by the receiving portion 142 of the wearable device 104, the identifier associated with the digital content and the security code are transferred to the wearable device 104.

In these previous examples and embodiments, once the identifier and the security code are transferred to the wearable device 104, the user 102 may activate audio play and/or visual display of digital content in numerous ways. In a first embodiment, and as depicted in FIG. 10, such activation occurs when the user 102 touches the object 108 with another object, such as a wand object 146. It should be appreciated that the wand object 146 is provided for illustrative purposes only and other objects are contemplated. In this first embodiment, the wand object 146 comprises an RFID tag and optionally a magnet, which, when brought into close enough proximity with the wearable device 104, the wand object 146 activates the read cycle of the active RFID reader in the wearable device 104.

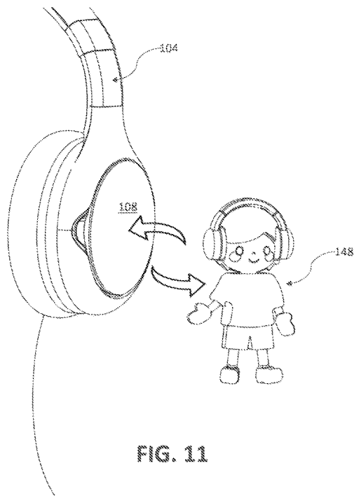

In a second embodiment, and as depicted in FIG. 11 and FIG. 12, such activation occurs when the user 102 touches the object 108 with another object, such as a figurine object 148. It should be appreciated that the figurine object 148 is provided for illustrative purposes only and other objects are contemplated. The figurine object 148 may be a toy, an animal figurine, or a mascot figurine, among other examples. In this second embodiment, the figurine object 148 comprises a magnet and an RFID tag, which, when brought into close enough proximity with the wearable device 104, the magnet of the figurine object 148 triggers the read cycle of the active RFID reader in the wearable device 104. It should be appreciated that these examples are provided for illustrative purposes only, and other examples are contemplated herein.

In additional examples, the wearable device 104 may be configured to transmit the digital content to another device via a wired means or a wireless means. In examples where the transfer occurs via the wired means, the wearable device 104 (e.g., the headphones) comprises a stereo jack connector for the wired transmission of the digital content. In some examples, the audio content may include radio broadcast content. The means to transmit the digital content may occur by any wireless communication method. In some examples, near field communication (NFC) protocols may be used for the communication between the wearable device 104 and the other device.

The NFC tag is not limited to facilitating access to digital content but may also serve multiple related functions, expanding its utility in diverse applications. First, it may form part of a multifactor security system. For instance, the tag can act as one aspect of a three-factor authentication process, complementing a security code associated with the device and a user-set password. Second, the NFC tag may be linked to a device ID and security ID pair and/or a digital token. This association enables functionalities such as altering device-user associations, incorporating a digital token into another device, deleting a digital token, or enabling the use of multiple tokens on a single device.

Additionally, the NFC tag can be associated with prior or external content ownership, beyond the content currently linked to the device or its related server. For example, it may facilitate the use of user-owned digital content from external libraries, such as Spotify or Amazon, with the device. The tag may also enable device functions and features, such as activating voice recognition. Moreover, the NFC tag can be coupled to aspects of digital content that form tradeable and/or purchasable objects. For instance, in an RPG game, the tag could activate purchasable enhancements, such as a more powerful sword, or unlock new storylines. These functionalities extend to after-market opportunities, enabling value-added features in gaming, education, entertainment, or information management through mechanisms like aftermarket sales. The concept encompasses not only NFC tags but also other objects capable of communicating digital content via alternative methods, such as Bluetooth or galvanic touch.

Further, the NFC tag may enable a device to join a local network of devices, activate multiplayer or multi-device features, or delete all information stored on the device. These versatile applications highlight the expansive potential of NFC tags in enhancing device functionality, security, and user experience.

Examples of the wireless connection means may include a Bluetooth connection, a radio broadcast technology, a mesh system, an Ultra-wideband (UWB) connection, or a Wi-Fi connection, among others not explicitly listed herein. As described herein, UWB is a radio-based communication technology for short-range use and fast and stable transmission of data. Other connection means are contemplated herein, such as a touch connection means or technology that occurs via galvanic or capacitive coupling by skin contact or another mechanism. Additionally, the one or more connection methods or means described herein may operate simultaneously in examples.

As shown in FIG. 7 and FIG. 8, the object 108 may also include a timer mechanism 144 to control a duration of the digital content playback, which may be set by the user 102 or another user (not shown). In an example, the other user may be a parent and the user 102 may be a child, such that the parent controls the duration of the digital content played back on the wearable device 104 being worn by the user 102.

In another example, the timer mechanism 144 may be a rotary encoder with an optical code or mark 164 (of FIG. 16) using for example, a grey scale printed on the inside of the object 108. It should be appreciated that UWB technology may be used herein in some examples. As the object 108 is rotated within the receiving portion 142 of the wearable device 104, the optical sensor array 150 (comprising one or more photo-elements, such as photodiodes or transistors arranged in an N×N matrix configuration) of the receiving portion 142 of the wearable device 104, with a light source shining on the scale, is used to detect the change in the grey scale pattern as it is rotated. The resulting serial data pattern is processed by the host microcontroller (“MCU”), and applying appropriate algorithms, the absolute or relative position of the rotary movement of the object 108 is determined. Depending on the particular implementation, features of the present invention may be achieved by implementing the MCU. Alternately, some implementations of the present invention may be implemented with embedded components that are configured and used to achieve a variety of features or signal processing.

An alternative mechanism includes using absolute discrete position sensing using an optical or electrical method. In this method, a plurality of optical sensors 152 or electrical contacts are arranged at N points around the circumference of the object 108. As the object 108 is rotated, the object 108 is arranged mechanically such that one or more of the sensors or contacts becomes engaged. In either method, the information obtained may be then used to set and control timing events.

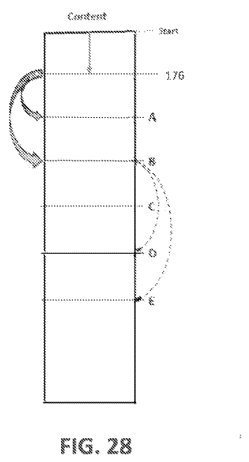

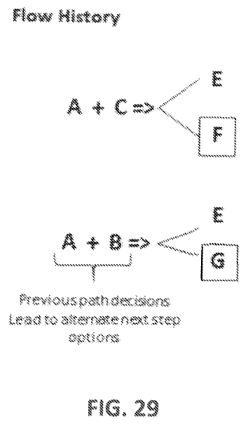

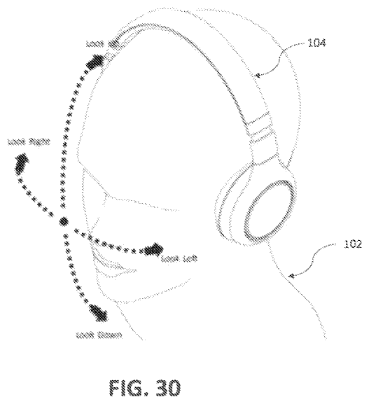

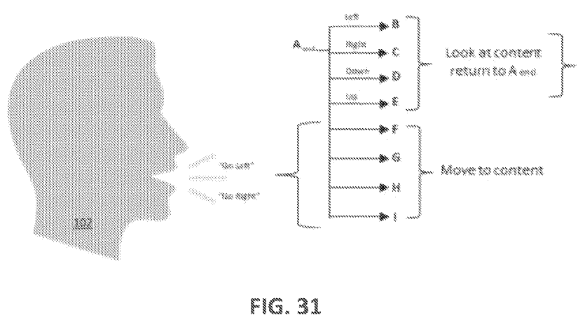

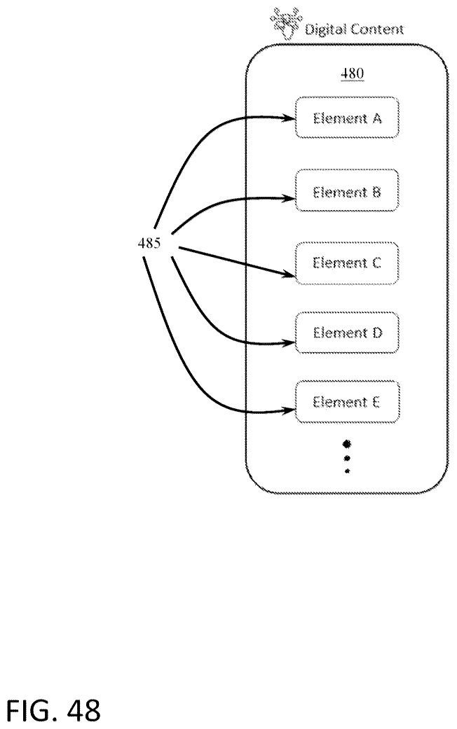

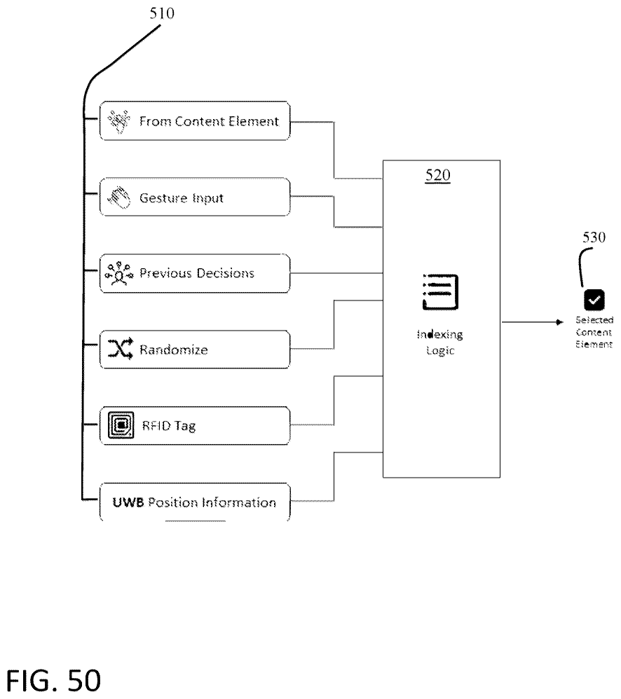

An indexing system as depicted at least in FIG. 48, FIG. 28, FIG. 29, FIG. 30, and FIG. 31, determines the flow of digital content elements. As shown in FIG. 48, in some embodiments elements of digital content 485 may be arranged as a set 480. The playback of the content elements 485 is managed by the indexing system, an overview of which is shown in FIG. 50. The indexing system may comprise a set of inputs 510, a logic system 520, and an output 530. As shown in FIG. 50, the indexing system accepts any of multiple possible inputs 510, which may be of different types. The inputs may also include inputs from other users in a multi user environment. Further, the inputs may be accepted either individually or in combination as a set 480 of inputs. The system then applies to these inputs logical processing as determined by indexing logic 520, and generates as an output 530 a selected digital content element to be played next.

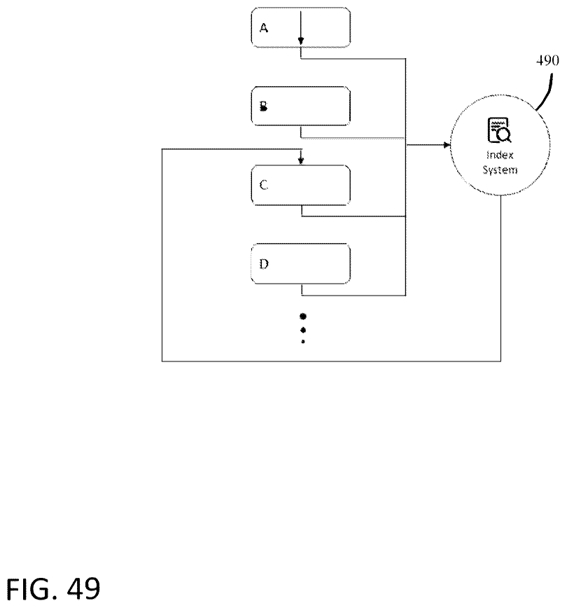

FIG. 49 shows the basic operation of such an indexing system. Each block A, B, C, D . . . represents a digital content element. At the end of each block, i.e., after the block's digital content element “plays,” the indexing system 490 is invoked and determines which block is to be played next. The logical flow from the end of a content element and through the indexing system identifies the next content element to be played. In embodiments, the next element to be played may simply be the next element in a predetermined sequence. Alternatively, the next element to be played may be determined by more involved logic set forth in the indexing system 490.

The user inputs may be classified based on any of a variety of characteristics of one or more users, one or more aspects of the system resources and/or the downloaded content they interact with, or other data not explicitly listed herein. The indexing system constitutes a relationship between the classification of one or more inputs and a discrete content element. By this means the indexing system when invoked may determine the content element that should be played by evaluating various data presented to it, including the classification of user inputs, historical activity, and the current system state.

In embodiments, a decision node 176 may require the user to choose one of two options such as an Option A or an Option B of FIG. 49, or an Option Left or an Option Right of FIG. 52. Once the decision is made, the index system defines the logic flow that determines the next selected option to be played. An example of this concept is a storyline in which the character reaches a fork in the road and the user must choose whether to ‘go left’ or ‘go right.’ FIG. 52 shows the user creating a gesture input to the indexing system which then selects the content element to be played.

Further, there are multiple methods by which a decision node 176 selection may be confirmed. Such methods include tactile methods, motion methods, and/or audio methods, among others not explicitly listed herein. In one example, tactile input methods include capacitive touch sensor elements and tactile switches. In another example, motion input methods may be derived from one or more accelerometers built into the wearable device 104. In other examples, audio inputs may be obtained with a combination of microphone elements and voice detection electronics and software, with the voice detection electronics residing either locally or as part of a cloud service.

In other examples, spatial position information may be used as inputs to the index system at a decision node 176. The spatial position information may be obtained in an absolute fashion from a fixed reference station within the space, or in a relative sense from the relative position between a plurality of devices. In some examples, the spatial position information may be obtained in high precision by use of UWB RF technology.

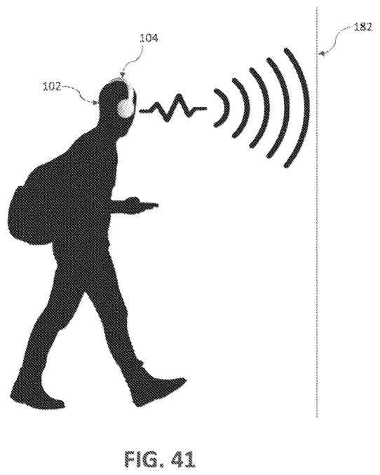

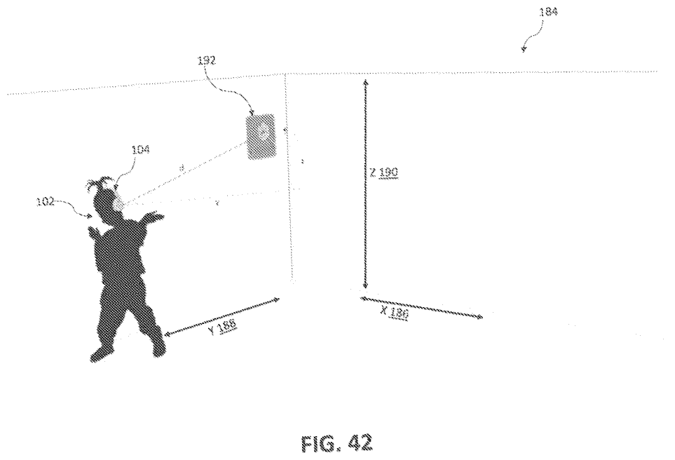

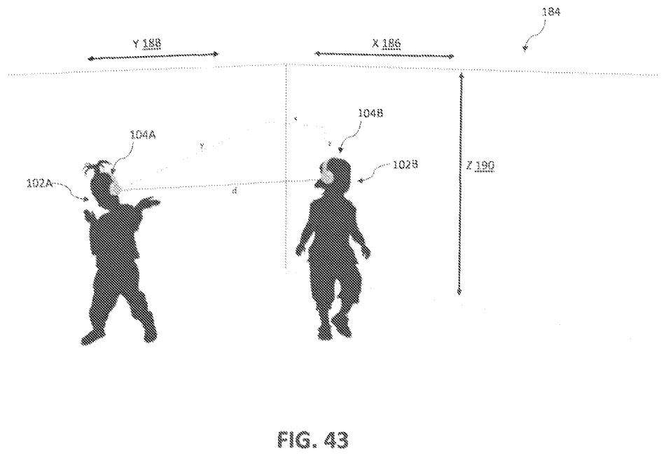

As an illustrative example, and as shown in FIG. 42 and FIG. 43, the wearable device 104 worn by the user 102 may be configured to locate its position in a defined space (such as a room 184 having an x-dimension 186, a y-dimension 188, and a z-dimension 190) and a respective position of one or more other devices or equipment (e.g., another device 192 of FIG. 42) in the defined space (e.g., the room 184) dynamically via one or more radio positioning technologies. Each of the one or more radio positioning technologies includes a Bluetooth technology, a BLE technology, an Ultra-wideband (UWB) technology, or a Wi-Fi technology, among other technologies not explicit listed herein.

The positional information may then be used as inputs to the index system to select a content element. As an example, the user may reach a decision node from current content that prompts them to “walk to the other side of the space.” When the user reaches the appropriate spatial position the index system would then register the spatial inputs and present the user with a content element e.g. “great! You have reached the right spot.” Alternatively, if the user moves to a spatial location other than intended, the spatial inputs to the index system may select alternative content, e.g., “You're not there yet, try again.”

Further, the spatial position input may be used asynchronously such that the content does not reach a decision node. Instead, a change in the spatial position input autonomously invokes the index system and thereby determines a next content element to be played.

Specifically, as shown in FIG. 43, a first user 102 A may be wearing a first wearable device 104 A and a second user 102 B may be wearing a second wearable device 104 B. Each of the first user 102 A and the second user 102 B may be located within the defined space (e.g., the room 184 having the x-dimension 186, the y-dimension 188, and the z-dimension 190). Each of the first wearable device 104 A and the second wearable device 104 B may be configured to locate its position in the defined space (e.g., the room 184) and a position of other devices or equipment in the defined space (e.g., the room 184) dynamically via the one or more radio positioning technologies. For example, the first wearable device 104 A may be configured to locate the position of the second wearable device 104 B in the room 184 and the second wearable device 104 B may be configured to locate the position of the first wearable device 104 A within the room 184.

Furthermore, in relation to the examples of FIG. 42 and FIG. 43, the digital content described herein is managed, distributed, or modified by the position of the other devices or equipment with respect to each other or by the position of the other devices or equipment in the defined space (e.g., the room 184).

As another example, the object 108 comprises the timer mechanism 144 (of FIG. 7 and FIG. 8) that is configured to control a duration of digital content playback. The timer mechanism 144 may be turned such that the object 108 is detected by a Hall sensor 154 of the wearable device 104. In another example, the method to generate inputs to the index system 176 may comprise detecting a movement of a head of the user 102 (as shown in FIG. 52).

In a more advanced implementation, the content flow does not stop at the decision node 176, but rather offers a temporarily limited period in which the user 102 may affect the content flow. There may be two or more possible paths for the user 102 to choose. A default progression of content is executed in the absence of intervention by the user 102. Further, the occurrence of the decision node 176 may be only inferred by the content and is not necessarily presented in the form of a question. As an illustrative example, assume the content comprises a story including the following line, “the character begins to climb a steep and high mountain.” The user 102 would then have the ability to choose to go back, keep climbing, or call for help, among others, without specifically prompting the user 102 to select one of those options and without stopping the content flow.

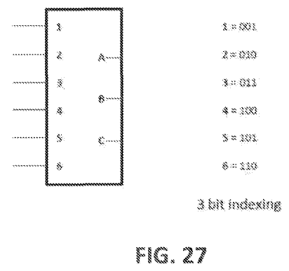

Additionally, the entry points are indexed positions in the content where the content flow may move to, based on the user's decision at the decision node 176. For example, in a story where a character reaches a river, there may be entry points for the following: (1) use the bridge to cross the river, (2) swim across the river, and/or (3) use the boat to row across the river, among others. Entry points may be referenced by a simple sequential set of numbers, such as those shown in FIG. 27, and the reference number is then associated with a physical memory offset, or filename.

Logic is a component of the indexing system that provides a mechanism for dynamic changes to the content flow. The logic system may function in a similar fashion to a fuzzy logic or neutral network system. That is, the corollary of multiple inputs may determine an output. As an illustrative example of reaching the river, if the user 102 or another user operating in a shared environment has already used the boat to attempt a river crossing, the weighting matrix has the related coefficient set to zero and a subsequent approach to the river crossing does not have the “use the boat” entry point as an option at that decision node 176. At each decision node 176 in the content flow, the user's decision input causes the modification of a weighting matrix (such as by setting or clearing a binary value) so that the presentation of future decision nodes and associated entry points is changed dynamically by the user's historical decisions.

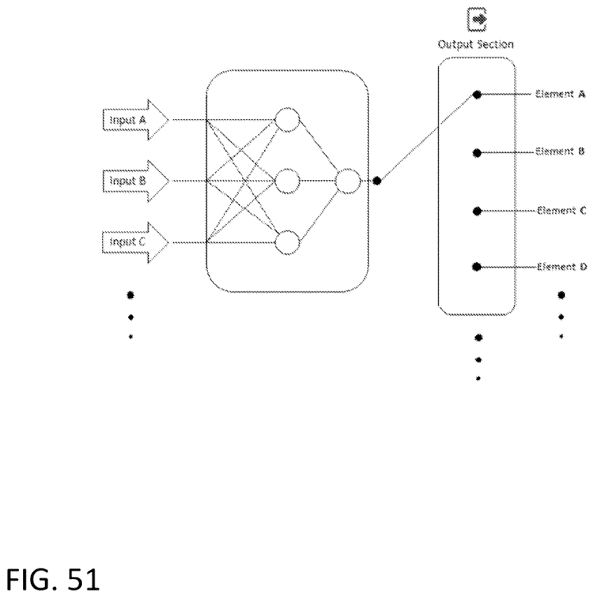

FIG. 51 illustrates the logic function 540 of the indexing system taking a multiple of inputs to generate an output. It should be appreciated that, as described herein, the user input may comprise: a gesture input, an audio input, a tactile input, and/or an absolute or relative special position input, among others.

FIG. 52 depicts an example gesture input (e.g., the user tilting their head while wearing the wearable device 104).

When these components are used in combination, the system functions in the following manner. First, a collection of content is provided that consists of content elements referenced by entry points. Each content element terminates with the decision node 176. When the user 102 begins a content element given by an entry point, a computation is made using the weighting matrix to resolve a list of possible entry points (including a default entry point) available to the user 102 when the decision node 176 at the end of the content element is reached. The user's decision input is used to modify the weighting matrix such that future outcomes (e.g., entry points available at a decision node) are altered. As a result, the user's progression through the content is determined based on previous decisions. Further, each time the user 102 begins a story, the content flow of the story may be modified based on previous passes through the content. As such, these components allow the user to jump to different parts of the content to build an interactive story.

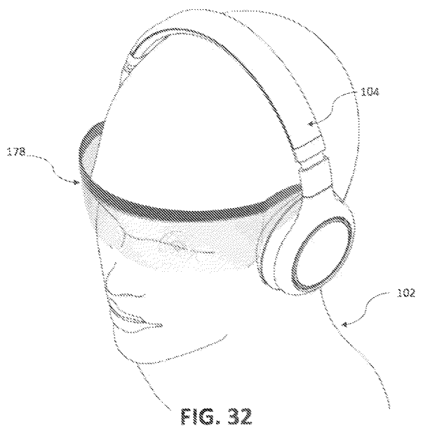

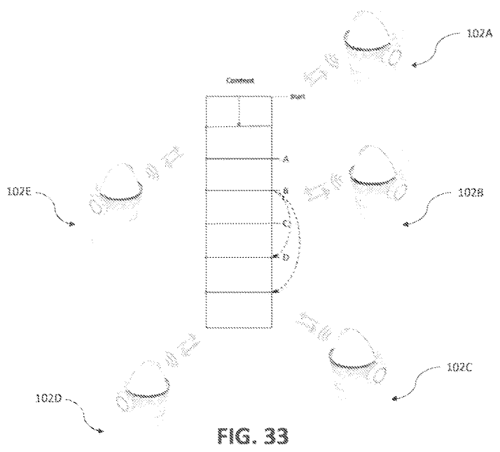

Moreover, in examples, one or more users may interact with the digital content via a connection to the wearable device 104. FIG. 32 and FIG. 33 depict perspective views of schematic diagrams of a first example of two or more users (e.g., a first user 102 A, a second user 102 B, a third user 102 C, a fourth user 102 D, and a fifth user 102 E) interacting with digital content via a connection to a wearable device 178 (e.g., smart glasses). In embodiments, each user may interact individually with the digital content. In other embodiments, a plurality of users may interact with the digital content in cooperation with some or all of the other users.

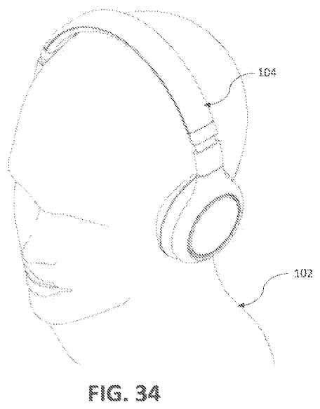

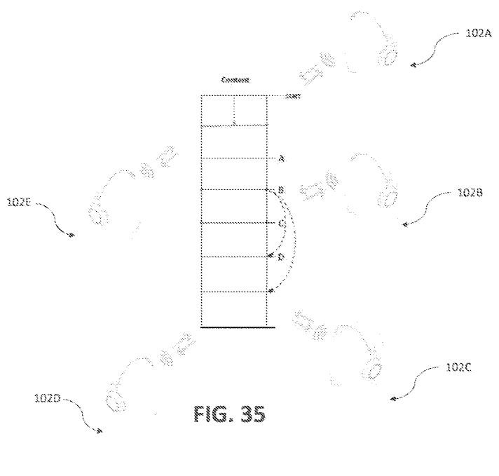

FIG. 34 and FIG. 35 depict perspective views of schematic diagrams of a second example of two or more users (e.g., the first user 102 A, the second user 102 B, the third user 102 C, the fourth user 102 D, and the fifth user 102 E) interacting with digital content via a connection to a wearable device 104 (e.g., headphones). In a first illustrative example, the connection described comprises a wired daisy-chained connection. In a second illustrative example, the connection comprises any wireless communication method. It should be appreciated that in some examples, the connection comprises future wireless technologies not explicitly described herein.

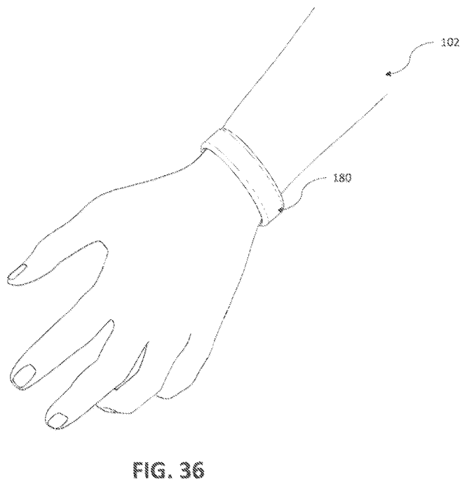

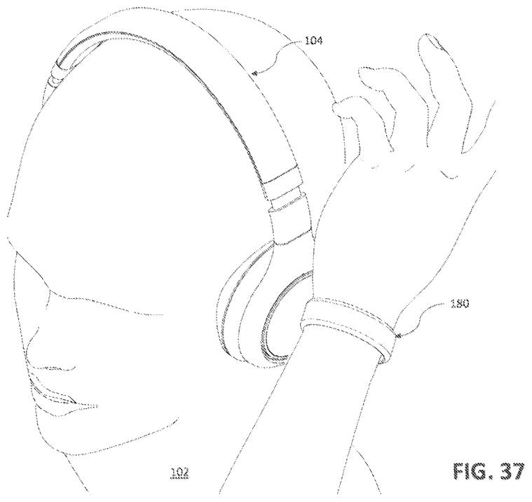

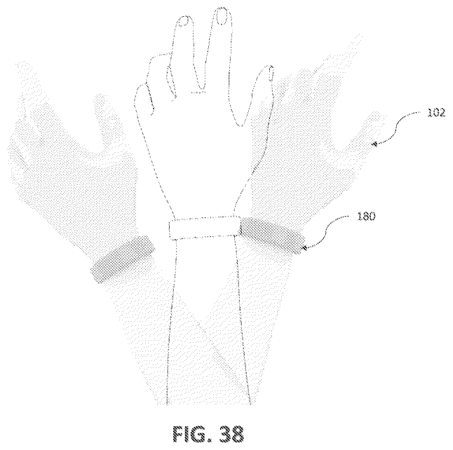

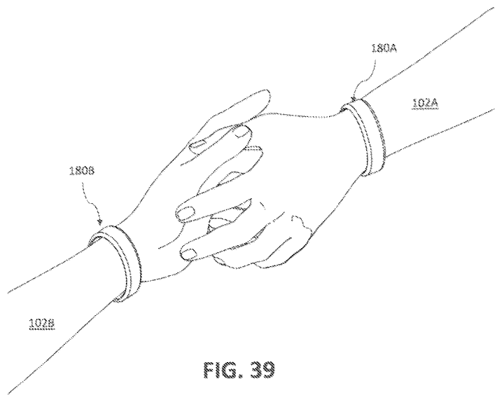

In another embodiment, and as shown in at least FIG. 36, FIG. 37, FIG. 38, and FIG. 39, the system described herein may comprise an ancillary device 180. The ancillary device 180 may be worn by the user 102. Moreover, the ancillary device 180 may be part of a body area network (BAN), a personal area network (PAN), or may otherwise function in conjunction with the wearable device 104, as shown in FIG. 37. As described herein, the BAN is a wireless network of wearable computing devices, such as the wearable device 104. Further, as described herein, PAN is a computer network for interconnecting electronic devices within a workspace of the user.

It should be appreciated that the ancillary device 180 incorporates a capacitive or a galvanic coupling functionality. Moreover, the ancillary device 180 is configured to communicate by touch via skin or other material contact to another capacitive or galvanic coupling enabled device or through near-field communication. As an illustrative example, and as shown in at least FIG. 36, FIG. 37, FIG. 38, and FIG. 39, the ancillary device 180 is a wearable bracelet that comprises a Bluetooth Low Energy (LE) functionality, any chip including, but not limited to, a RFID sensor, and a galvanic coupling technology such that the ancillary device 180 may communicate by touch to another capacitive or galvanic coupling enabled device (e.g., the wearable device 104, as shown in FIG. 37) or through near-field communication.

FIG. 38 depicts a hand gesture or movement occurring while the user 102 is wearing the ancillary device 180. Furthermore, FIG. 39 depicts a first ancillary device 180 A worn by a first user 102 A and a second ancillary device 180 B worn by a second user 102 B, where the first ancillary device 180 A and the second ancillary device 180 B are configured to communicate by touch via skin or other material contact with one another or through near-field communication. It should be appreciated that though the ancillary device 180 is depicted as a wearable bracelet, the ancillary device 180 is not limited to such and other configurations of the ancillary device 180 are contemplated herein.

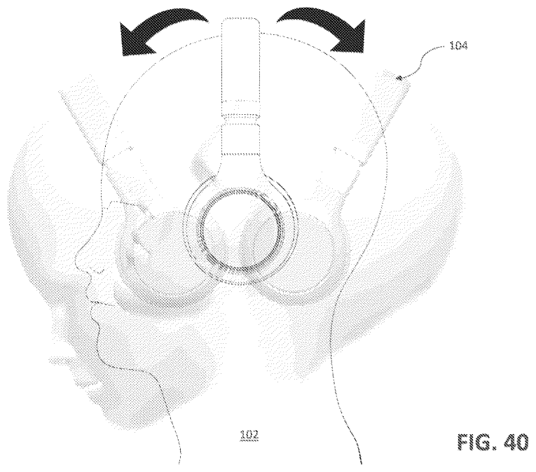

FIG. 40 illustrates of a head nodding movement occurring while the user 102 is wearing the wearable device 104.

In further examples, and as shown in at least FIG. 41, the wearable device 104 comprises one or more sensors configured to detect a physical location in relation to other physical objects located within a close proximity. In examples, each of the one or more sensors may be an ultrasonic distance sensor, a laser distance sensor, an infrared distance sensor, a RFID sensor, or a radar sensor, among other sensors not explicitly listed herein. Specifically, as depicted in FIG. 41, the wearable device 104 worn by the user 102 may comprise one or more proximity sensors that are configured to detect a distance from the wearable device 104 (and thus the user 102) to an object, such as a wall 182.

As previously described, an object 108 may interface directly with a receiving portion 142 of a wearable device 104 using near field communication (NFC). In embodiments, the object 108 may be received by and affixed to the receiving portion 142 of the wearable device 104 via a mechanical means or a magnetic means, or any other appropriate means not explicitly described herein. The receiving portion 142 of the wearable device 104 may also include one or more speakers and/or other sensory outputs.

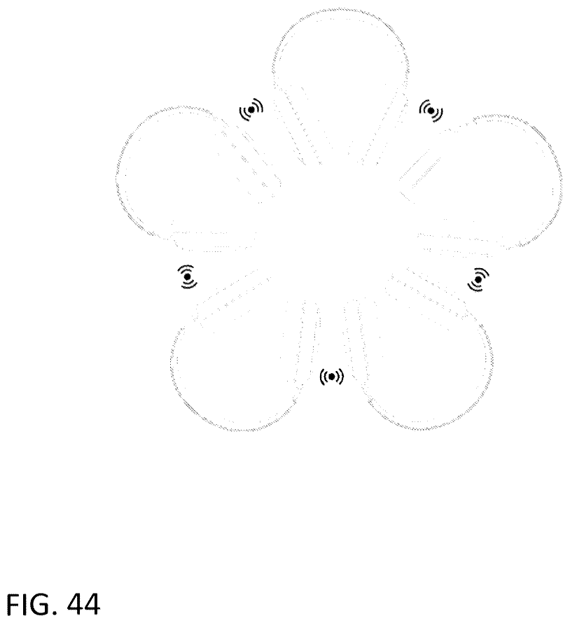

However, in other embodiments, other arrangements of system elements and users may be used. For example, multiple objects 108 may be received and affixed to a device 104. Moreover, one or more such objects may include their own receiving portion and affixing method, or the wearable devices 104 may themselves may comprise respective receiving portions. FIG. 44 illustrates a configuration in which multiple parties form a network and communicate with each other, using any conventional wired or wireless communications and network protocols appropriate for the usage environment and scenario in which they are operating.

FIG. 45 illustrates a user 102 wearing a virtual reality (VR) or enhanced reality (ER) headset 400 that includes over the ear headphones 410 and a personal visual display 420. An earpiece 415 of the wearable device 400 comprises an electronic receiver 158, as was depicted in FIG. 15. As before an object 108, here in the form of a wand, comprises an electronic transmitter and a battery. In this embodiment, when the object 108 is brought into proximity of the earpiece 415, the identifier associated with the digital content and the security code stored in object 108 are transferred to the headset 400.

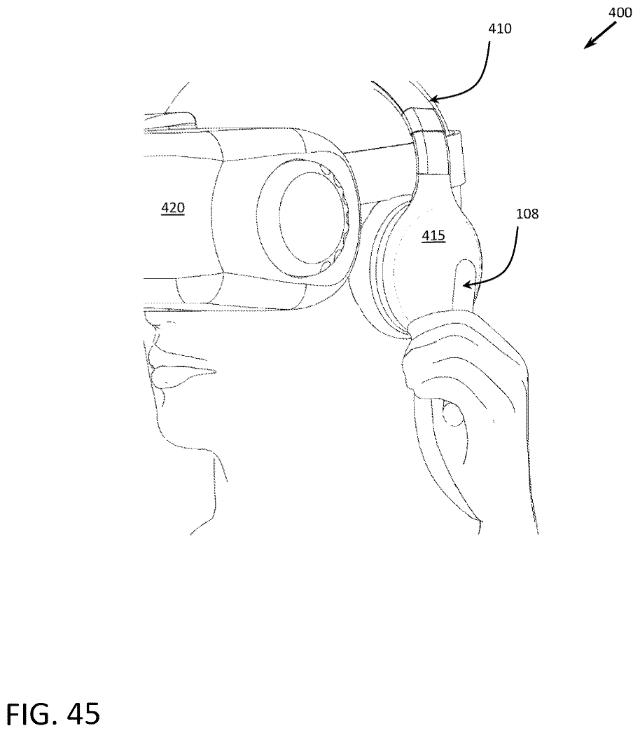

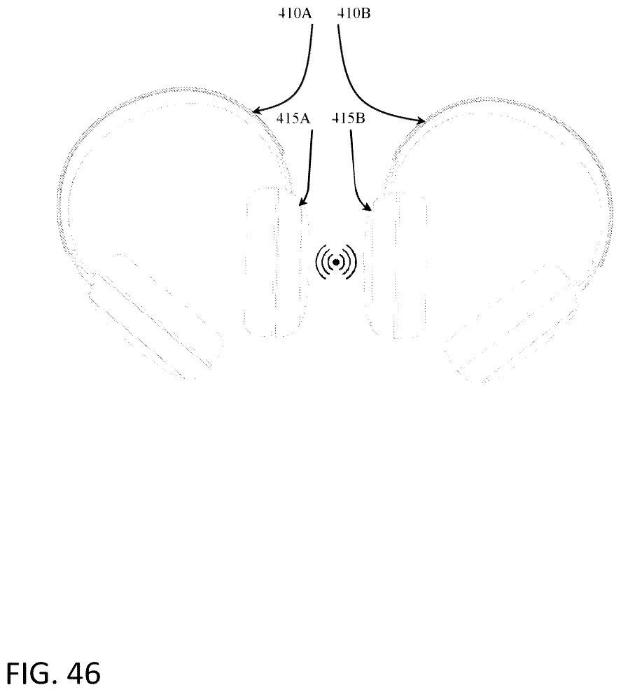

FIG. 46 shows two sets of over the head earphones 410 A, 410 B, each configured to communicate wirelessly with the other when brought into close proximity to each other. In this embodiment, an earpiece 415 A, 415 B of each set of headphones contains a transmitter, a receiver, a data storage device, and a battery coupled to each. They are configured to detect when they are brought into proximity with each other, and to transfer at least some of their respective stored data between them.

In embodiments, an object containing a passive RFID tag interacts with a device containing an active RFID tag reader, wherein the device reads an RFID tag of the object by bringing the object into close proximity with the device, so that near field communication (NFC), Bluetooth, or the like between the object and the device may function. The object may be any convenient type of a first device comprising an RFID tag, which is brought into close proximity of any second convenient type of a second device comprising an RFID tag reader, to read the information in the tag. The first and second types of device may be the same type or different types. In embodiments, a single device may comprise both an RFID tag and an RFID reader, or may otherwise include both of their functionalities in any convenient alternative configuration.

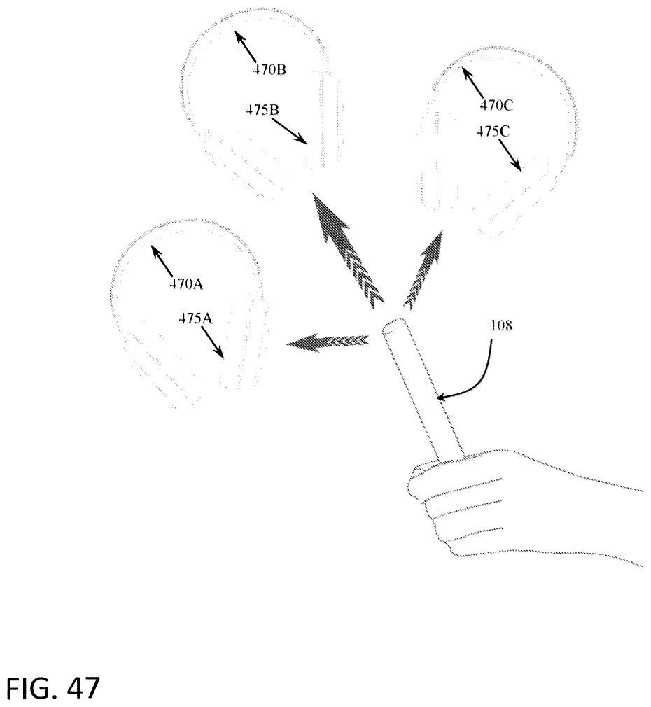

In embodiments, the object may interact with multiple devices. FIG. 47 shows a single object (a wand) that includes an RFID tag. When the wand is brought in proximity to one or more user devices, those proximate devices respectively interact with the wand to read the RFID tag in the wand.

In the embodiment illustrated in FIG. 47, three sets of headphones 470 A, 4706, 470 C are shown. Each contains a respective earpiece 475 A, 475 B, 475 C containing a battery coupled to a receiver, which may be an active RFID reader. The receiver is configured to detect an object when brought into close proximity, such as a wand 108. The object (wand) contains a data storage device having data stored therein, which may be included in a passive RFID tag. As shown, the data in the wand is transferred to each of the earpieces when it is brought into their respective proximities. The data transferred may include an identifier associated with secured digital content, and a security code needed to obtain the digital content. After the identifier and the security code are transferred to the respective headphones, the user wearing the headphones may activate audio play of the digital content in any convenient manner.

Multiple objects may be read by multiple devices to authorize digital content download from the cloud based server, and/or to authorize uploading of content to a cloud based server, and/or to authorize upload or download (i.e., sending or receiving) of content between devices. The devices may also be configured to input data into their respective indices, to include but not be limited to acting as a decision node, to input into the index to authorize content playback, and/or to affect the order of the index content blocks. The RFID tag of an object may also be used to active hardware and software functions of one or more of the devices, such as allowing augmented reality display, and/or multiplayer usage of a game, and/or the connection or inclusion of an ancillary peripheral device. Other feature and function options may additionally or optionally be provided and/or allowed.

FIG. 48 illustrates an example embodiment of an index system 480 in which any appropriate kind of digital content is arranged as a set of content elements 485. The presentation of one or more of the content elements 485 is controlled by the indexing system 480. The index system 480 manages the selection of content elements played to the user by mapping a set of inputs to an output that selects a specific content element.

One or more of the content elements 485 may be retrieved from a cloud service or other source, either singly or as a group. FIG. 48 shows such digital content as a collection of content elements 485. The content elements may be retrieved from a cloud server or another paired device on demand. Consequently, the content elements 485 may be updated and/or changed dynamically to give the user an ever evolving experience.

FIG. 49 shows a simple implementation of an indexing system 480, wherein each content element A, B, C, D, . . . provides a logical input to the indexing system, and the indexing system then generates a logical output to point to the next content element to be played. More generally, the indexing system operates as a logic system to map various inputs to respective specific outputs, the outputs being respective content elements to be played next.

As illustrated in FIG. 50, various inputs may include a content element just finished, or gesture inputs, or other inputs from the user. Inputs may additionally or alternative be determined based at least in part on previous selections, positional information from an UWB system, proximity of one or more physical objects (such as other headphones, wands etc.), and/or an interaction with a RFID tag. Some degree of randomization may also influence a choice of an output.

Further, the indexing system may use a logical network to determine a content element to play next based on a multiple of inputs. This is illustrated in FIG. 51, which shows a logic network in which multiple inputs are used to produce a output selection.

In one example of the behavior of the indexing system, a set of content elements may be mapped to be played in sequence. If so, when the indexing system receives an input that constitutes or includes the end of a content element or series of elements, it may then select the next element in a predetermined sequence.

FIG. 52 illustrates another example in which a particular content element ends by giving the user a choice of options. For example, content elements may include go left or go right at a fork in a road. The user may then provide a gesture input (or other type of input) that the index system uses to determine an appropriate next content element to play. Of course, the next content element to play may be associated with the user's choice.

The indexing system may also incorporate additional logic that may modify the output. For example, a content element may play the following: “you reach a bridge that spans across the river, do you cross the bridge or continue along the river side?” In one instance the user may choose to cross the bridge and be provided with the following content: “the bridge creaks and groans and just as you reach the middle its collapses and you fall into the river.” However, on another occasion the choice to cross the river may produce the content “the bridge is wobbly and unsteady but finally you reach the other side.” The indexing system here is producing outputs that are not fixed, but are dynamic. In this example the output of the indexing system resulting from crossing the bridge may come from a selection that is at least partially random, and/or may be at least partially computed from factors such as the number of times the bridge cross option has been used previously. For example, the ‘bridge’ may weaken with each use and finally collapses.

In embodiments, the indexing system supports a multiple user environment. In this case the indexing system responds to input from the shared environment. In a multiple user environment, the index system may maintain synchronization with all users, or one or more users may operate independently of the others, or a combination of these may be configured.

For example, a content element may prompt a user to pass a token to another user. The token may be a ‘wand,’ and once the wand is passed to another user the indexing system would respond accordingly, recognizing that the wand is held by the other user.

Another example is a shared environment in which a game of hide and seek is played. At the outset of the game the indexing system recognizes all users and may provide the ‘finder’ with content elements indicating the hidden status of other users. As hidden users are found, the indexing system then excludes content elements related to them because they are out of the game.

In one example configuration, when a new user enters a shared environment, one or more content elements related to that user become available to all users. Such new users may join a shared environment by means of proximity detection, NFC communication, or other methods not explicitly described.

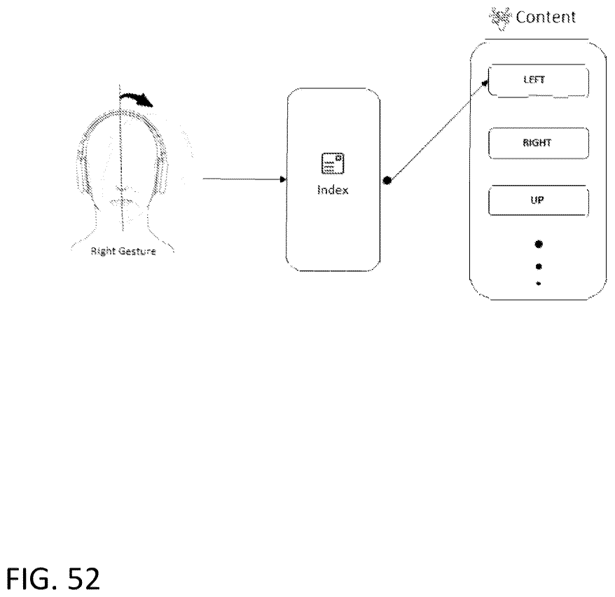

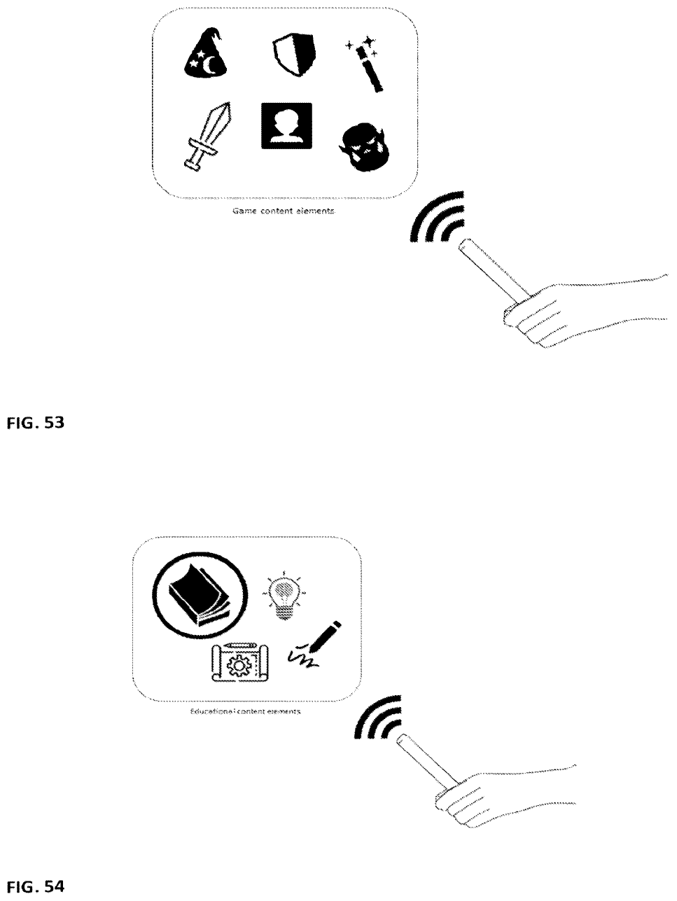

FIG. 53 illustrates the basic operation of an exemplary indexing system. Each block represents a content element. At the end of each block the indexing system is invoked and determines which block to be played next. The arrows show that the next block may or may not be the next element in a sequence, as determined by the element selected by the indexing system.

Aspects of the present invention are described herein with reference to block diagrams of methods and systems according to embodiments of the invention. It will be understood that each block and combinations of blocks in the diagrams, may be implemented by the computer readable program instructions.

The block diagrams in the Figures illustrate the architecture, functionality, and operation of possible implementations of systems and methods according to various embodiments of the present invention. In this regard, each block in the block diagrams may represent a module, a segment, or a portion of executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block and combinations of blocks may be implemented by special purpose hardware-based systems that perform the specified functions or acts or carry out combinations of special purpose hardware and computer instructions.

As described herein, a wired, wireless, and/or touch connection methods or technologies may be used. Example wireless connection methods may include a Bluetooth connection, a radio broadcast technology, a mesh system, an UWB connection or a Wi-Fi connection, among others not explicitly listed herein. Furthermore, touch connection mechanisms or methods include galvanic or capacitive coupling by skin contact or another mechanism. Additionally, one or more of these connection methods or means may operate simultaneously.

Another embodiment of the invention provides a method that performs the process steps on a subscription, advertising, and/or fee basis. That is, a service provider may offer to assist in the method steps of downloading or streaming digital content from the server directly into the wearable device. In this case, the service provider may create, maintain, and/or support, etc. a computer infrastructure that performs the process steps for one or more customers. In return, the service provider may receive payment from the customer(s) under a subscription and/or fee agreement, and/or the service provider may receive payment from the sale of advertising content to one or more third parties.

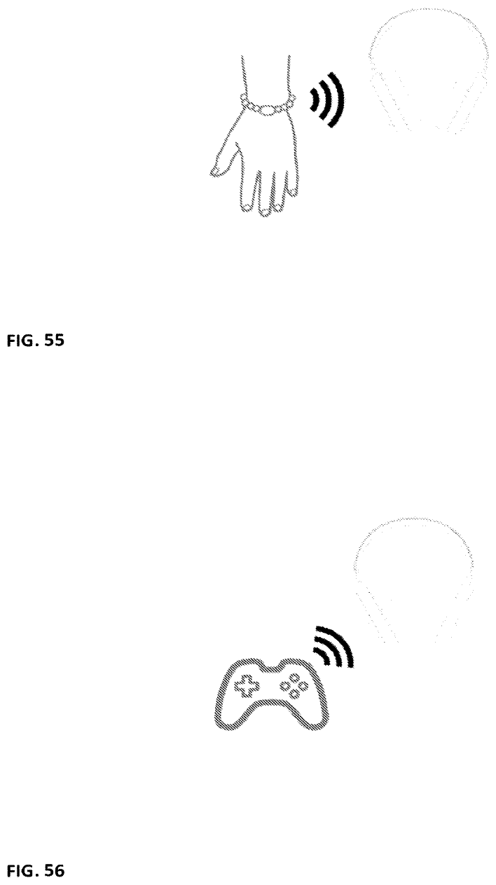

Another embodiment of the invention has a system of the device and an object where the object includes an RFID tag where the tag is not required to download digital content but provides a variety of other functions as depicted in FIG. 45 when brought into proximity with the device. The object tag read by the device may activate content elements stored in the index of the device, FIG. 54 illustrates gaming content elements, FIG. 55 illustrates a peripheral device with an RFID tag being brought into proximity to a device such that the device recognizes and authorizes the use of the peripheral in the system where the peripheral is a bracelet. Other embodiments of the use of the RFID tag are shown in FIG. 55 and FIG. 56 where the object is in the form of peripheral devices which use the RFID tag to be recognized by the device. Another embodiment of the use of the tag in FIG. 45, is to activate functions and features of the mechanical or software capabilities of the device such as to allow augmented reality features like a heads-up display (HUD) or a licensed true surround audio or voice recognition or diffuse infrared communication.

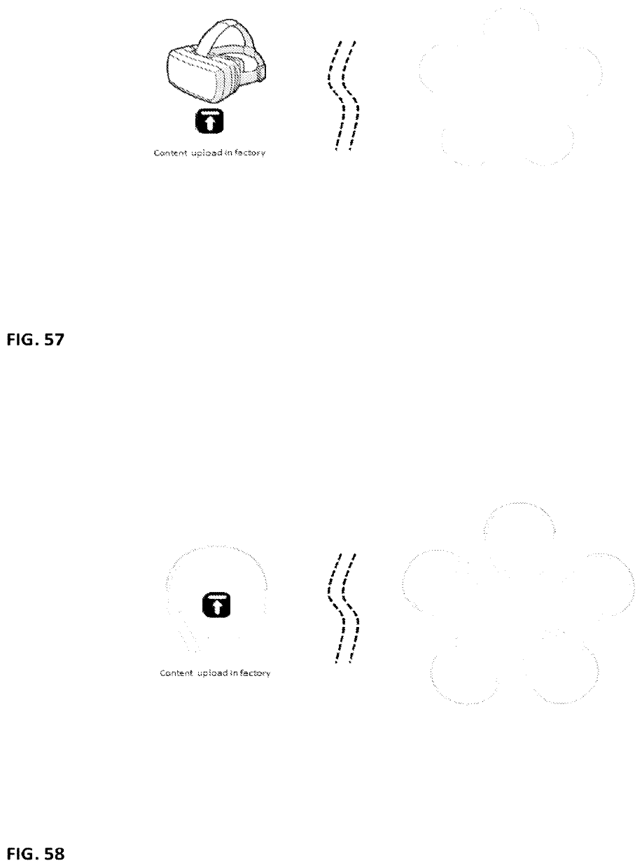

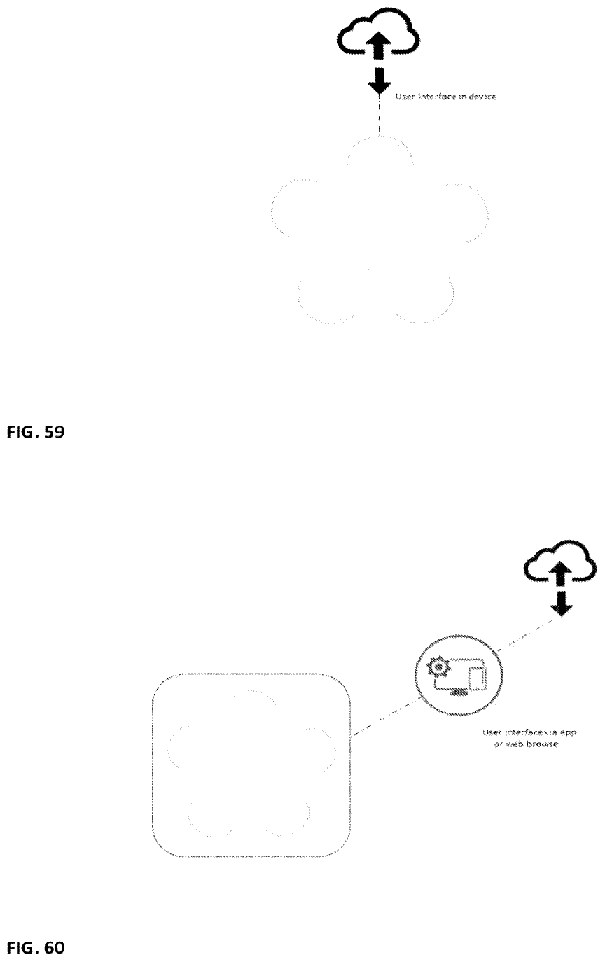

A device and system in which an RFID tag is not used to authorize downloading content, may have had digital content preloaded into the device prior to purchase of the device by the end user. Preloading of digital content may occur at the factory level, or digital content may be downloaded from a cloud portal through convention means of a user interface in the device or an external user interface such as a conventional app or web browser hosted on a phone or personal computer. FIG. 57 illustrates the device as a virtual reality headset having the digital content uploaded prior to purchase. FIG. 58 illustrates the device as a headphone having the digital content uploaded prior to purchase. FIG. 59 illustrates the device interacting with a cloud server with the user interface incorporated into the device. FIG. 60 illustrates the device interacting with a cloud server with the user interface hosted externally, with communication to a phone or PC by the device where the portal app or web browser is hosted. The device may obtain digital content by a hybrid of these methods, having some digital content uploaded at the factory level and other digital content downloaded from a cloud server.

In another embodiment the device may interact via a cloud server with other devices to form a wide area network to create a conventional multiplayer gaming environment.

In another embodiment the index of the device may interact with an index hosted on a cloud server wherein input to both indexes occurs in real time, and the index of the server is part of the active system.

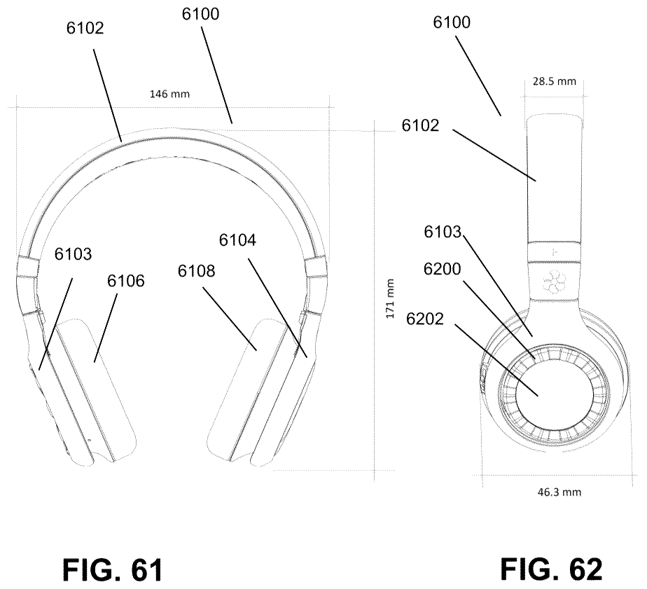

FIGS. 61-72 illustrate example methods and systems for implementing a system controller for an audio system in a pair of headphones such as, a wireless headset. In an embodiment, the wireless headset employs a touch-controlled LCD screen on the left ear cup, which enables audio playback from a local bulk data storage medium housed within the headset. Through an associated mobile application, users, such as a caregiver and/or a parent may download and/or organize age-appropriate content for their children, eliminating the need for a continuous Wi-Fi connection and/or a separate smart device. This configuration extends battery life and allows independent audio playback of music, audiobooks, and/or other stored content. In an embodiment, the system offers portability and screen-free functionality, allowing children, for example, to access audio content in diverse environments.

For example, the headset employs intuitive controls suitable for young users and incorporates parental control features, including but, not limited to, a volume limiting component. In an embodiment, the wireless headset is configured to contain no advertisements, screens, or cameras, providing a secure, parent-monitored experience. The device may have a built-in accelerometer that enables interactive content control through motion-based input, supporting content such as, interactive audiobooks. In an embodiment the headset also functions as traditional headphones with both Bluetooth and cable connectivity. The rotating bezel on the menu interface enables selection of stored audio, and the device may have a memory to store up to approximately 1,000 audio files with a battery life of approximately 20 hours, with no Wi-Fi required following initial setup.

In an embodiment, the wireless headset employs a platform to enhance connectivity and user interface (UI) capabilities. Connectivity improvements include but, are not limited to, support for the Wi-Fi band and an increased data rate, enabling broader access point compatibility and reducing download times. Optionally, the upgraded Wi-Fi interface may support content streaming.

In an embodiment, the wireless headset employs an updated visual and touch-based UI menu, allowing users to navigate and control the device independently of the smartphone application. This interface enables users to browse and queue content from their library, adjust track position with fine control, and configure settings such as volume limits and playtime restrictions. Additionally, this UI may optionally support direct content rating and feedback from the device.

FIG. 61 illustrates an example of a set of headphones 6100 implementing a near-ear audio system in accordance with some embodiments. The set of headphones 6100 are composed of several key components to facilitate delivering audio such as one or more drivers (not shown). The one or more drivers are responsible for converting electrical signals into sound, with various types such as dynamic, balanced armature, planar magnetic, and electrostatic. A first ear cup 6103 and a second ear cup 6104 house the drivers and are positioned over the ears. Comfort is provided by the first ear pad 6106 and the second ear pad 6108, or cushions, which may be made from materials including, but not limited to, foam, leather, or fabric, influencing both sound quality and noise isolation. Connecting the first ear cup 6103 and the second ear cup 6104 is the headband 6102, which rests on the head of a user (not shown) and is adjustable for a proper fit, and may be padded for additional comfort.

The set of headphones 6100 provides a screen-free audio experience, in which the GUI of the set of headphones 6100 is not in alignment with a user's eyes during use, enabling users to engage with content without requiring a separate device for playback, creating a focused, distraction-free environment for audio interaction. As a portable entertainment hub, the headphones 6100 may store a substantial library of audio content, allowing users, including but not limited to, a child, to access a variety of stories and educational material whether at home or on the go. In an embodiment, the set of headphones is configured with interactive learning in mind, the set of headphones 6100 facilitates continuous educational engagement by providing on-demand playback for a range of content that supports both entertainment and learning.

In embodiments the set of headphones 6100 fosters independent exploration, encouraging creativity and imagination through audio storytelling, and offers a convenient solution for parents, for example, seeking a safe, enriching audio environment for their children without constant supervision. In embodiments, the set of headphones 6100 redefines audio entertainment by delivering an interactive, screen-free, and mobile experience that promotes learning and enjoyment, wherever and whenever desired.

FIG. 62 illustrates the set of headphones 6100 of FIG. 61 employing a control system with a GUI 6202 and a rotating bezel 6200 located at the first ear cup 6103.

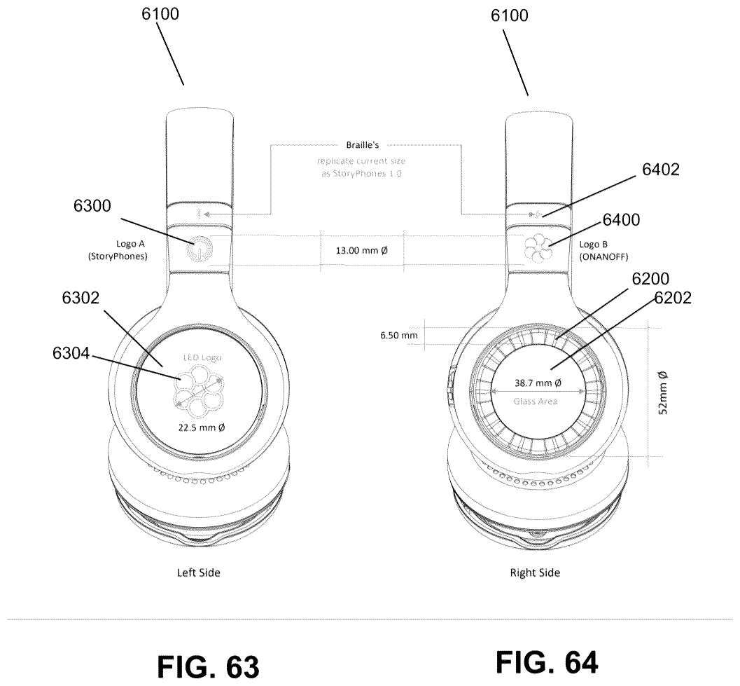

FIG. 63 illustrates the set of headphones 6100 of FIG. 61 employing a control system with a near field communication (NFC) reader 6302 and one or more light emitting diodes (LEDs) 6304 to illuminate. Logo icon A 6300 is located on set of headphones 6100.

FIG. 64 illustrates the set of headphones 6100 of FIG. 61 employing the GUI 6202 and the rotating bezel 6200 of FIG. 62. Logo icon B 6400 is oriented between surface indicia 6402 such as Braile.

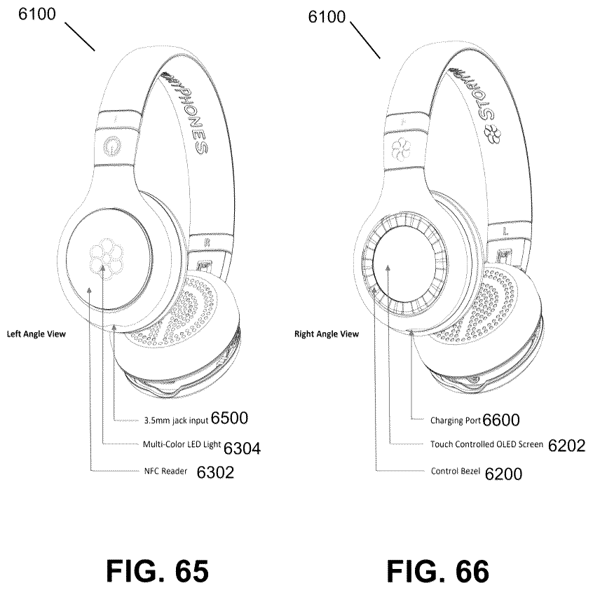

FIG. 65 illustrates the set of headphones 6100 of FIG. 61 employing a control system with the NFC reader 6302 and one or more LEDs 6304. The one or more LEDs 6304 may be multicolored and/or a single color. A jack input 6500 is located at an ear cup.

FIG. 66 illustrates the set of headphones 6100 of FIG. 61 employing the control system with the GUI 6202 and the rotating bezel 6200 of FIGS. 62 and 64 and a charging port 6600. A rotary encoder (not shown) is a component that detects rotational movements, often used to adjust settings such as, volume and/or menu selection. In a pair of headphones, this rotary encoder is typically embedded within a rotatable bezel, which is a ring or dial around an ear cup. When the bezel is turned, the rotary encoder inside registers the movement and sends the corresponding signal, allowing users to control settings by rotating the bezel.

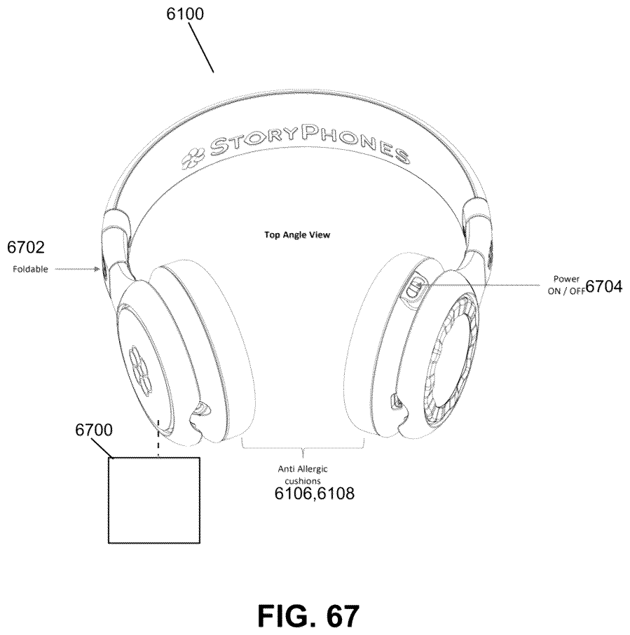

FIG. 67 illustrates the set of headphones 6100 of FIG. 61 employing a hingedly pivotable folding mechanism 6702 oriented in an open configuration. The set of headphones 6100 has one or more sensors 6700 including, but not limited to, an accelerometer. Power switch 6704 may be touched by a user to orient the power source in an on and off configuration. The first ear pad 6106 and the second ear pad 6108 may be made from hypoallergenic materials to ensure comfort and reduce the risk of irritation for sensitive skin. Examples of materials include but are not limited to, medical-grade silicone, memory foam with an antimicrobial coating, and/or a soft, breathable fabric such as microfiber or leatherette with hypoallergenic properties. These materials are designed to provide a comfortable fit while minimizing the chance of allergic reactions during prolonged use.

The set of headphones 6100 may have a local bulk data storage medium, which may be replaceable to enhance storage capacity. As illustrated in FIG. 67, the headphones may incorporate one or more sensors, designated as sensor 6700, including but not limited to an accelerometer, gyroscope, and inertial measurement unit (IMU), which are designed to detect body movements for the purpose of enabling interactive storytelling. The IMU is capable of sensing various motions, such as forward and backward movement, jumping, turning, nodding, and shaking of the head. These detected movements are transmitted to the processor to activate modifications in the interactive narrative. In an embodiment, the accelerometer is a sensor that detects broader movements, orientation changes, and acceleration. The accelerometer is configured for pausing playback when the headphones are removed and/or changing settings based on specific movements.

In one embodiment, the set of headphones 6100 includes voice detection capabilities for facilitating interactive storytelling. The headphones may also be powered by a power source, such as a 1000 milliampere-hour (mAh) battery or an alternative battery configuration that allows for sufficient capacity. Furthermore, the headphones may feature a capacity-wearing detector that automatically powers off the GUI when worn on the user's head and pauses content playback while illuminating the display when the headphones are removed.

In another embodiment, the power switch consists of a three-position mechanism. Sliding the switch upward activates story mode; holding it in the upward position allows for a reset; and sliding it downward switches off story mode while enabling Bluetooth (BT) pairing. This mechanism is similar to the operation found in the Bang & Olufsen (B&O) Beoplay H7 model, which utilizes a side slide-and-hold feature. Additionally, the internal battery is connected to the printed circuit board assembly (PCBA) using clips that are user-replaceable, facilitating end-user self-pairing. Access to the battery is achieved by detaching the twist-off ear cushions and removing the fasteners, such as screws, from the speaker baffle plate.

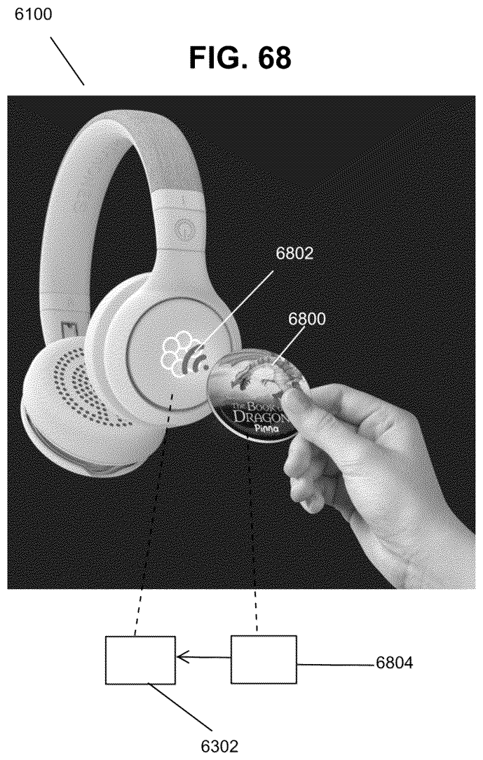

FIG. 68 illustrates a perspective view of an NFC tag 6804 implemented at an object 6800 that may be magnetically coupled via electromagnetic induction with the set of headphones 6100 of FIG. 61. In an embodiment, the NFC tag 6804 of the object 6800 may transmit a data link data 6802 to NFC reader 6302 to implement digital content download.

The ONANOFF backend is a digital content management system that allows downloading and management of media for the headphones. It supports two primary methods for content transfer. First, parents or guardians may use a dedicated iOS or Android app on their smartphone or tablet to manage the content available on the headphones. Through this app, they may download, curate, and control the media, ensuring it is suitable and tailored for the listener. Alternatively, the ONANOFF backend offers an interactive way to activate content downloads using an NFC-enabled object called a StoryShield. When this StoryShield is tapped or brought near within a proximity of the NFC reader, embedded in the left ear cup of the headphones, it activates a “tap-to-download” function, allowing content to be transferred directly from the backend without the need for a mobile app. Once the content is downloaded, playback may start automatically, and future playbacks may be controlled either via the touch screen menu on the headphones or by tapping the StoryShield to the left ear cup again. This system combines convenience and control, making it easy to update content and ensure that only approved media is accessible for listening.

In an example embodiment, the set of stereo Bluetooth headphones, is configured for audio playback with a focus on storytelling, including, but not limited to, children's storytelling. Equipped with Bluetooth capabilities, it features a speaker driver and Environmental Noise Cancellation (ENC) for clear hands-free speech. In an embodiment, it includes including, but not limited to, a local bulk data storage medium for substantial story storage, supports iOS and Android applications, and offers a predetermined audio playback time. Charging is facilitated through any means including, but not limited to, a USB Type-C cable, and the device may implement a power source such as, a rechargeable battery, which is end-user replaceable. An RGB LED system, for example, is included to indicate charging status and low battery levels.

The headphone controls are intuitive, catering to ease of use for children. A physical slide switch provides a simple way to toggle between modes: the center position is “off,” a push up initiates story mode, while pushing down activates Bluetooth pairing. A reset may be activated by sliding up and holding from the story mode position. The touch screen control includes various options: a central button for multiple functions (Play/Pause/Answer Call/End Call), left-side skip back, and right-side skip forward. Volume control and menu navigation are managed by a rotating ring, with plans to explore a capacitive touch solution. A Near Field Communication (NFC) reader is integrated under the left cup to facilitate StoryShield downloads.

In an embodiment, the touch screen menu and rotating bezel allow children to select stories on their own, creating an engaging and independent experience. The headphones may store one or more stories, ensuring a diverse range of content. Basic control options include play, rewind, fast-forward, and volume adjustments, which are easy to operate even for young users. LED indicators enhance user experience by signaling device status: blue for power on, flashing blue for Bluetooth pairing, solid blue when Bluetooth is paired, flashing red for low battery, and solid red during charging (which extinguishes upon full charge).

In terms of audio inputs, the headphones support several options: backend download of audio tracks through the screen menu or mobile app, Wi-Fi audio streaming, Bluetooth wireless streaming, and a stereo audio jack. Bluetooth features include both audio streaming and hands-free communication, with BLE support for additional device control and data link to the app. Additionally, an HFP microphone is integrated for hands-free functions.

As noted above, the set of headphones is configured with children in mind, prioritizing simplicity, durability, and user-friendly features. The device combines audio playback with storytelling, creating an interactive and educational experience for young listeners. In an embodiment, the system includes Bluetooth and audio codec support, making it versatile for both playback and hands-free communication. The integration of NFC for story downloads, touch screen controls, and a rotating bezel enhances usability, while the large storage capacity of 16 GB ensures access to a wide variety of stories. Additionally, the end-user replaceable battery and standard USB Type-C charging provide practical maintenance options, aligning with modern standards. Overall, these headphones leverage advanced audio technology and child-centered design to offer an interactive storytelling.

As noted above, the headphones are Wi-Fi-enabled Bluetooth headphones configured to connect to the ONANOFF backend and utilize content provider SDKs to deliver kid-friendly digital content. A display including, but not limited to, a circular TFT LCD touch screen is located on the ear cup, which serves as the primary user interface, along with an integrated rotating bezel that encircles the display. This bezel allows for intuitive control of content selection and volume adjustment. Additionally, the left ear cup contains an NFC reader to enable streamlined content management through tap-based interactions. The headphones support at least a dual-band Wi-Fi and Bluetooth with LE audio capabilities, allowing for high-quality audio streaming and connectivity. An audio jack is also included, supporting both audio input from an external source and output for sharing audio with a second passive headset, such as for story mode or Bluetooth streaming.

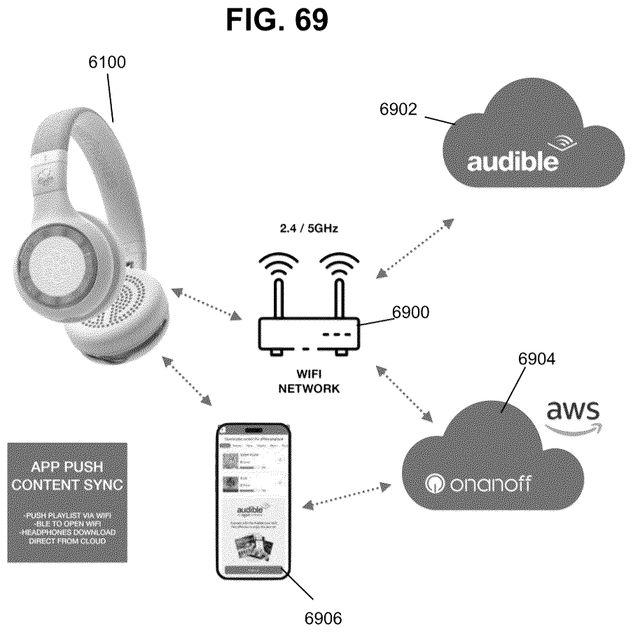

FIG. 69 illustrates the set of headphones 6100 of FIG. 61 employing a data link to a cloud storage location where a digital content file is stored. The set of headphones 6100 is in communication with Wi-Fi network 6900. The Wi-Fi network 6900 is in communication with a digital content user verification system 6902 such as, audible, as well as a digital content management system 6904 such as, ONANOFF. The set of headphones 6100 is in communication with an electronic device 6906 such as, a smartphone. The smartphone or the electronic device 6906 is in communication with the digital content management system 6904.

The set of headphones 6100 builds upon the capabilities of the original platform by enhancing connectivity and user interface (UI) features. In an embodiment, connectivity improvements include the integration of dual-band Wi-Fi, enabling a higher data rate for faster downloads and broader access point compatibility, and optional content streaming capabilities for more flexible audio experiences. Additionally, the set of headphones 6100 incorporates a visual and touch-based UI that enables users to manage the device independently of any smartphone application. This upgraded UI facilitates content navigation, selection, and queueing within the user's audio library, precise track-position adjustment, and straightforward configuration of modes such as volume limits and playtime restrictions. Users may also be able to directly rate and like content from the device, further enriching their interactive experience.

In an embodiment, the set of headphones 6100 is a screen-free audio device that includes an index screen solely for story selection. Once a story is chosen, the display turns off, providing a distraction-free audio experience. Equipped with 16 GB of memory, the set of headphones 6100 may store one or more stories, offering substantial audio content capacity for children. In an embodiment, the device may employ one or more sensor's including, but not limited to, an accelerometer and/or gyroscope enable interactive experiences, allowing users to engage with content through movement, ideal for interactive audiobooks like “Choose Your Adventure.” Accessories include a charging cable and a travel case, ensuring the headphones are convenient for on-the-go use.

The set of headphones 6100 offers several advanced, AI-driven features for immersive, personalized storytelling. The “AI-Driven Stories” function allows users to customize story parameters, including the child's name and preferred narrative style, creating a unique story generation experience tailored to their choices, with approval options for parental control. The “Magical Stories” feature, enabled by a built-in accelerometer, allows users to interact with audio content through simple movements, enhancing engagement in an innovative way. Additionally, “Storyoke” enables a karaoke-style storytelling experience where users may read along with storylines displayed on-screen, accompanied by synchronized sound effects for a dynamic storytelling session. “MyStories” allows personal recordings, enabling family members to create and share custom stories or songs with personalized artwork, ensuring children may listen to the voices of loved ones even when they are not nearby. Together, these features transform the set of headphones 6100 into a versatile, interactive audio platform that blends creativity, technology, and personal connection.

In an embodiment, a wireless and/or a wires connection such as with a cable (not shown) connects the headphones to the audio source, such as a smartphone, computer, or audio player. In an embodiment the set of headphones 6100 utilize wireless technology via Bluetooth. The connector, typically a 3.5 mm jack, ¼ inch (6.35 mm) jack, or USB connector, links the headphone cable to the audio device. The headphones may include control buttons or touch interfaces for adjusting volume, playback, and answering calls. For those with active noise cancellation (ANC), extra microphones and circuitry are incorporated to detect external sounds and generate sound waves to cancel them. Finally, wireless models contain a rechargeable battery that powers the device and features like ANC and Bluetooth connectivity. Together, these components create a high-quality audio experience, with designs varying widely depending on the type of headphones, such as over-ear, on-ear, in-ear, or true wireless models.

The set of headphones 6100 integrates advanced security and technical features tailored for a broad range of Internet of Things (IoT) applications. It utilizes the EdgeLock SE050 secure element (SE) product family, which provides enhanced Common Criteria EAL 6+ and FIPS 140-2 certified security. This high level of security safeguards against modern attack scenarios, offering robust protection with an extended feature set designed for IoT use cases. The EdgeLock SE050 acts as a root of trust at the IC level, ensuring true end-to-end security from edge to cloud. Notably, this security solution simplifies implementation by eliminating the need to write security code or handle keys and credentials.

When Bluetooth (BT) is activated by sliding the main switch to a lower position, additional activation by a touch screen button is under consideration. In BT mode, the device's screen and rotary dial provide BT controls: the rotary dial functions as a volume control, while the screen supports multifunctional button (MFB) actions in the center, forward skip on the right touch area, and back skip on the left touch area. The final layout of on-screen buttons is pending the design team's input.

The set of headphones 6100 incorporates movement detection, voice commands, and noise detection to enable interactive storytelling. Playback is paused while awaiting sensor input, and the story's progression is influenced by these sensor-activated actions. Other technical specifications include Bluetooth 5.4, SBC, AAC, and LC3 codec support, with the ability for parents to curate content via an app, as the headphones cannot download content directly via Wi-Fi.

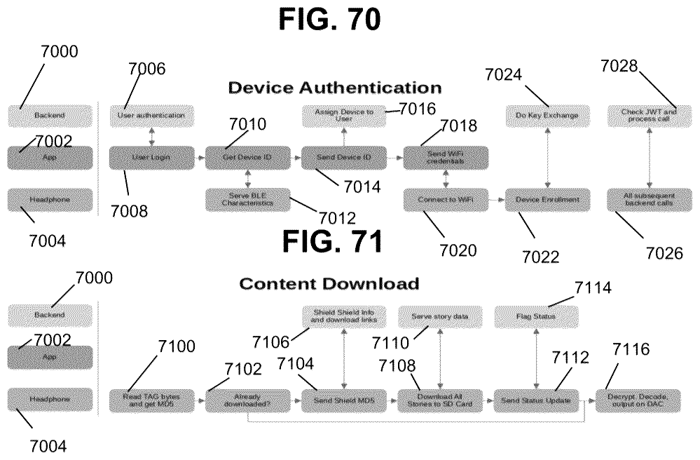

FIG. 70 illustrates a diagram illustrating a process of device authentication employed by the set of headphones of FIG. 61 in accordance with some embodiments. In FIG. 70, the Device Authentication process begins with the backend server 7000, which manages communications between the application 7002 and the headphones 7004. The user initiates this process by logging into the app 7008, activating User Authentication 7006 to verify their credentials. Upon successful login, the app retrieves the unique Device ID of the headphones 7010 and sends BLE Characteristics to the backend 7012 for identification purposes. The app then transmits the Device ID to the backend 7014, which in turn Assigns the Device to the User 7016, linking it to their account. Following this, the app sends Wi-Fi credentials to the headphones 7018, allowing them to Connect to Wi-Fi 7020. Once connected, the headphones undergo Device Enrollment 7022 to access the system fully. A Key Exchange 7024 is performed to establish a secure connection. Finally, the backend verifies the JSON Web Token (JWT) to process the request 7026, allowing the headphones to make subsequent authorized backend calls 7028.

FIG. 71 illustrates a diagram illustrating a process of content download employed by the set of headphones of FIG. 61 in accordance with some embodiments. In FIG. 71, the Content Download process begins with the headphones reading TAG Bytes and calculating an MD5 hash for integrity verification 7100. The app then retrieves Shield Info and download links from the backend 7102 and checks whether the content has already been downloaded 7104 to avoid duplication. If necessary, the app sends the calculated MD5 hash 7106 to verify the content's integrity. Following this, the app may download one or more stories to the headphones' local bulk data storage medium 7108, while the backend Serves Story Data 7110. The headphones send a Status Update to the backend 7112 to report download progress or completion. The backend then Flags the Status of the content 7114, marking it as ready for playback. Finally, the headphones decrypt and decode the downloaded content, outputting it through the Digital-to-Analog Converter (DAC) for audio playback 7116.

The set of headphones 6100 incorporates a streamlined authentication process, designed for a one-time device verification phase. Following this, the headphones use a signed JWT (JSON Web Token) containing necessary credentials for all subsequent API calls to the backend server, ensuring secure data exchange. For content download, the headphones obtain a list of download links for each audio file (e.g., “story”) and proceed to download and store these files on the local bulk data storage medium. During playback, the stored content is decrypted into the .ogg audio format and decoded for output through the DAC (Digital-to-Analog Converter).

Integration with platforms like Audible may necessitate structural adjustments to the authentication process, primarily replacing device authentication with user-only authentication. Audible's authentication API and encryption methods enable configuring the system architecture to support these requirements. This could involve direct user credential transfer to the headphones to log in and generate an access token, which might require securely storing login credentials within the device. Alternatively, another authentication method could be implemented, potentially avoiding persistent credential storage on the headphones.

Given the device's user interface, browsing extensive content libraries may not be feasible; instead, content flagged as “liked” or pre-selected through a parent-controlled app could be downloaded directly to the headphones. Efficient content encryption and decryption mechanisms will need to be selected carefully to optimize processing speed and power consumption on the headphones' MCU (Microcontroller Unit). Additionally, the download functionality could incorporate expiration settings for content access, depending on usage requirements. In sum, implementing secure authentication and efficient content management in a streamlined, user-friendly manner will be essential to enhancing the user experience with the set of headphones 6100.

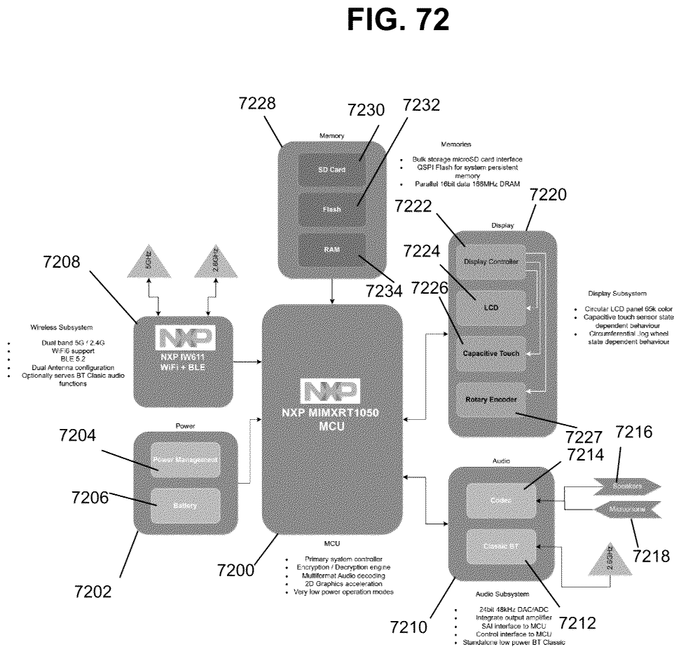

FIG. 72 illustrates a diagram of a system controller implemented in the headphones of FIG. 61, having a wireless subsystem, an audio subsystem, a display subsystem, memory, and a power source in accordance with some embodiments. The diagram in FIG. 72 outlines the components and subsystem organization of the NXP MIMXRT1050-based MCU system for a set of headphones, broken down into functional blocks. At the center, 7200 is the NXP MIMXRT1050 MCU, which serves as the primary system controller. It manages many functions such as encryption/decryption, multi-format audio decoding, 2D graphics acceleration, and power-efficient operational modes.

To the left, 7202 represents the Power Subsystem. It includes 7204 for power management and 7206 for the battery, responsible for supplying and regulating power throughout the system. Above the MCU, 7208 is the Wireless Subsystem, which supports dual-band Wi-Fi and Bluetooth. It features dual antennas and optionally handles Bluetooth Classic audio functionality, enabling wireless connectivity and streaming. On the right side of the MCU, 7220 is the Display Subsystem, featuring 7222 the Display Controller, which interfaces with various display components. These components include 7224 for the LCD, 7226 for capacitive touch sensors, and 7234 for a rotary encoder 7227. This subsystem includes a circular LCD panel with 65K color capability, capacitive touch sensing, and a jog wheel for state-dependent interaction.

Above the Display Subsystem, 7228 represents Memory components. This includes 7230, which is the local bulk data storage medium, 7232 as flash memory for persistent data, and 7222 for RAM, providing memory resources for processing and data storage. To the lower right of the MCU, 7210 represents the Audio Subsystem. This includes a means for digital-to-analog and analog-to-digital conversion, along with an integrated output amplifier, 7212 for classic Bluetooth functionality, and a serial audio interface for direct integration with the MCU. This subsystem supports playback via 7214 (Speakers) and input via 7216 (Microphone). Finally, 7218 denotes an antenna specifically configured to facilitate Bluetooth operations, optimizing the connection for audio data transfer.

The set of headphones incorporates a MCU (Microcontroller Unit), which serves as the central controller for managing various functions within the device. This integration allows for effective processing of audio signals, control of power distribution, and communication with external devices through various protocols. The MCU enhances the overall functionality of the headphones by enabling real-time processing, ensuring efficient operation, and facilitating seamless interaction with connected peripherals.

An MCU (Microcontroller Unit) system controller is a component that integrates multiple functions within a system, primarily overseeing the operation of hardware components. Serving as the brain of the system, the MCU executes control algorithms and processes data from various subsystems, including sensors and communication modules. It interfaces with peripherals such as displays, audio components, and input devices, managing their operations and ensuring effective communication. Additionally, the MCU controls power distribution among system components, optimizing energy consumption and extending battery life in portable devices. It facilitates communication between different subsystems and external devices through various protocols, including Bluetooth, Wi-Fi, and NFC. Many MCUs are engineered for real-time processing, enabling quick responses to inputs and environmental changes. Furthermore, MCUs are programmable, allowing them to perform specific tasks and making them suitable for diverse applications ranging from consumer electronics to industrial systems. In summary, the MCU system controller plays a vital role in coordinating the various functions of a device, providing control and communication capabilities while ensuring efficient operation.

In an embodiment, one or more AI processors may facilitate model training, offered by chip manufacturers for example, optimized power consumption, and/or advanced sensor fusion capabilities. Unlike traditional systems that typically rely on IMUs, such as accelerometers and gyroscopes, alongside MCUs, AI processors may integrate with a wider range of sensors, allowing for greater flexibility in future system configurations. These processors enhance applications by improving sensor accuracy, enabling the selection of content tailored to specific user needs and/or creating unique, non-replicable content to deliver personalized user experiences.

In one embodiment, a set of headphones may employ one or more sensors capable of detecting a user's unique biosignature. Biometric sensors capable of capturing data for unique biosignatures include a range of technologies designed to measure physiological and behavioral traits. In an example, one or more electrocardiogram (ECG) sensors may monitor heart activity, providing a unique signature based on the electrical impulses generated by the heart. In another example, one or more galvanic skin response (GSR) sensors measure skin conductivity, which varies with stress or emotional states. IN yet another example, one or more photoplethysmogram (PPG) sensors detect blood flow and oxygenation levels, often through light absorption variations in the skin, to provide pulse and vascular characteristics. Additionally, inertial measurement units (IMUs) with accelerometers and gyroscopes may capture motion patterns, which, when combined with other sensors, enhance authentication reliability. Advanced implementations may also use skin temperature sensors or contact-based skin impedance measurements to assess physical stress and health conditions. Together, these sensors enable robust and multi-dimensional biometric authentication systems. These sensors enable wireless transmission of user authentication data, such as for access control. The system may integrate galvanic coupling to implement two-factor authentication, requiring the individual to be conscious, within normal physiological stress limits, and physically interacting with an entry pad to gain access.

In an embodiment, the set of headphones may be in communication with one or more biometric sensors to capture and process unique physiological data for user authentication and interaction. In an example, retinal scanning may be implemented through one or more infrared sensors that detect the patterns of blood vessels in the user's eye when positioned correctly. In another example, facial recognition is achieved using embedded cameras and depth sensors to map facial features, such as the distance between eyes and the contour of the jawline. In another example, palm and/or fingerprint recognition may be incorporated via touch-sensitive surfaces, such as the GUI, on the headphones or companion devices, using optical and/or capacitive scanners to analyze vein patterns, hand geometry, and/or fingerprint ridges. In an embodiment, the set of headphones process the captured biometric data with one or more onboard algorithms, converting the captured biometric data into digital templates for real-time authentication and/or role assignment during user interactions.

An embodiment of the disclosed set of headphones integrates advanced sensor technology and AI-driven systems to enhance interactive content experiences. The headphones enable users to engage with pre-purchased or user-generated story content in a “create-your-own-adventure” format. In an embodiment, one or more biometric sensors in communication with the set of headphones are configured to capture at least physiological and emotional responses, such as heart rate, skin conductivity, and motion, which are analyzed in real time by an one more processors. This adaptive system dynamically modifies the narrative path and content delivery based on the user's responses, creating personalized and immersive storytelling experiences. The technology further allows multi-sensory interaction and unique content customization, making each user experience distinct and non-replicable.

In an embodiment, the set of headphones may implement gamified applications involving multiple users and device interactions, in which an authorized user may activate a device by touch. For example, a designated “sorcerer” may activate a “magic sword,” which, when touched by another player, triggers an in-game consequence such as “death.” An associated app may automatically assign user roles, creating differentiated permissions for interacting with other objects. These objects may include additional connected headphone devices, wireless charging docks, speaker docks, and/or headphone-specific game accessories.

In an embodiment, the set of headphones has wireless charging functionality that supports advanced interaction with, for example, a charging dock and/or a charging stand. When the set of headphones are docked, the system may transition audio output from the headphones to an external loudspeaker in communication with the charging stand, enabling hands-free or shared listening. Additionally, docking facilitates data transfer via the wireless charging interface with embedded communication channels to offload and/or synchronize data between the headphones and the charging stand. This capability could include uploading user preferences, session logs, and/or game progress to an associated device or cloud storage. In an embodiment, for gamification applications, the docking process itself may serve as a functional element within gameplay. For example, docking the headphones could trigger an in-game event such as reaching a “safe zone,” completing a mission objective, or recharging virtual resources. This interaction provides a physical layer of engagement, blending real-world actions with digital outcomes to enhance the immersive user experience.

In an embodiment, the set of headphones may implement a digital token system to replace the need for physical NFC tags traditionally required for content access, enabling digital content to be downloaded, stored, and/or played directly from the device, such as the set of headphones. Users may acquire rights to digital content virtually through online platforms, mobile apps, or other mechanisms without reliance on physical tags. These rights are encapsulated in a digital token, license key, or information package that validates the association between the headphone, user account, and content.

Digital tokens may be stored locally on the headphone and/or managed by a remote backend server. Digital tokens encode usage parameters such as time limits (e.g., trial periods or special offers) and/or playback counts (e.g., restricted to a finite number of uses before requiring renewal). For instance, if a headphone is reassigned to a new user account, pre-stored content for which the second user lacks rights becomes inaccessible unless a new token is obtained. This token system also supports preloaded content on headphones, where users need only obtain the token to unlock access without downloading the content again. Tokens may be compact in size, allowing for efficient transmission via Bluetooth low energy (BLE) from a smartphone app to the headphone, avoiding large data downloads, especially in low-bandwidth scenarios.

Users interact with the system through a graphical interface on the headphone, a rotatable bezel, physical buttons, gesture controls, and/or a connected control device to manage and play content. Content stored on the headphone is tagged with internal permissions to define access rights, allowing playback without a physical NFC tag. Unlike prior systems where playback depended entirely on the presence of a physical NFC tag, this implementation grants playback permissions based on the digital token.

Periodic synchronization between the headphone and a backend server updates the content library. During synchronization, the system reconciles discrepancies such as identifying content that the user has rights to but lacks locally and/or content stored locally without corresponding rights. The headphone may then autonomously download permitted content and/or delete unauthorized files to optimize local storage. Automatic removal prioritizes infrequently used content to accommodate new purchases. Limited synchronization processes target specific content, such as newly purchased items, initiated by a connected smartphone app via BLE. The app may also send placeholder thumbnail images to indicate pending downloads, ensuring users are aware of completed transactions. A download priority queue with pause, resume, and retry functionalities manages multiple downloads efficiently, addressing interruptions from power loss, network failures, or user actions.

In an embodiment, the headphone incorporates a dynamic content sorting system to organize extensive content libraries. Sorting algorithms may use static logic and/or machine learning models to generate personalized content orderings, enhancing user experience by prioritizing relevant or frequently accessed files. In an example, the implementation of sorting algorithms in a set of headphones combines static logic and/or machine learning models to dynamically organize a user's content library. The process begins with data collection and preprocessing, where metadata such as title, genre, play duration, play count, last accessed timestamp, and user ratings are gathered. Additional information, such as user behavior (e.g., skipped content, replayed items) and contextual data (e.g., time of day, geographic location), is also logged. This data is normalized to ensure consistency in processing. Static logic-based sorting uses predefined rules, such as prioritizing recently added content, frequently accessed items, or content aligned with time-based contexts (e.g., calming tracks in the evening). Users can also define custom sorting preferences, such as by genre or duration.

In an example embodiment, machine learning models, including but not limited to, collaborative filtering, content-based filtering, and/or recurrent neural networks (RNNs), are trained on at least historical user data to predict preferences. These models consider features like metadata, behavior patterns, and inferred user satisfaction (e.g., completion rates). A hybrid approach integrates static rules and/or machine learning predictions using a weighted scoring system to generate a final content ranking. For instance, static attributes like “last accessed” and “play count” may be blended with model predictions to achieve personalized results. The GUI allows interaction with the sorting system, enabling users to toggle between static and dynamic modes, adjust priorities, or filter content by specific tags (e.g., “interactive adventures”). Backend synchronization ensures seamless updates to metadata, user logs, and machine learning models. Periodic syncing also enables the deletion of rarely used content to free storage for new downloads. Real-time updates ensure that the sorting dynamically adapts to user behavior, such as elevating calming tracks if the user consistently selects such content in the evening. In another example, performance optimization may be facilitated through A/B testing and/or evaluation of metrics such as engagement rates and user satisfaction scores, to name a few examples. The sorting system is designed for speed and efficiency, ensuring smooth operation even with large libraries. In an embodiment, the set of headphones implements a system wherein a digital token interacts with a security code to enable various functionalities. The headphones provide secure access to digital content stored on the device, manage permissions for app downloads and installations, and offer enhanced security features such as two-factor or multi-factor authentication. These features may operate independently or in conjunction with a smartphone app or blockchain network to facilitate access or impose restrictions on content. The headphones may be modular in construction, allowing interchangeable components such as an LCD module, bulk memory, cushions, headbands, or other parts. This modular design accommodates functional customization, ergonomic adjustments, or aesthetic changes. Interchangeable components may also include sensors for detecting environmental factors, user actions (e.g., motion or voice commands), or physiological signals such as temperature, heart rate, or brain activity.

In an embodiment, the digital token is integrated into the headphones and may be configured to grant and/or restrict access to digital content based on the security code associated with the device. The token may also incorporate content rights previously obtained by the user, either through token authentication or via authorization using the security code. Content sources may include authorized device applications or third-party providers such as streaming services. Restrictions may apply to the type of content accessed, such as limiting availability to child-appropriate material. Additionally, the security code may enable content-sharing permissions, multiplayer functionality across devices, or activation of specific features such as voice recognition or enhanced content elements. The token system includes mechanisms to manage ownership, allowing for transferability or restricting usage to a single device or user. The device supports multiple tokens stored simultaneously and enables the same token to be utilized across multiple devices. In implementations, the system also includes a backend server and device integration that allows for permanent deletion of ownership or usage records upon request. Usage data generated by the headphones can be recorded and shared, with users able to opt in or out of data-sharing configurations via the device or its accompanying application.

, local bulk data storage medium SD card access, and audio playback. Wireless connectivity is handled by a dedicated NXP IW611 chip, which provides Wi-Fi 6 and Bluetooth Low Energy (BLE) capabilities for seamless integration with mobile devices. To ensure robust security, the 6100 headphones utilize the NXP EdgeLock SE050 secure element, which is Common Criteria EAL 6+ and FIPS 140-2 certified. This secure element offers advanced protection against modern attack scenarios and an extensive feature set suitable for various IoT applications. By establishing a hardware-based root of trust, it enables end-to-end security from the edge to the cloud, eliminating the need to implement security code or manage keys and credentials directly.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

When introducing elements of the present disclosure or the embodiments thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A system, comprising:
a security code assigned to a device;
a control system comprising:
a graphical user interface (GUI);
a user authentication system, comprising:
a user account in communication with the security code of the device to authenticate the user account;
a digital content management system comprising:
a database of encrypted digital content, the encrypted digital content is associated with an identifier;
a digital token assigned to the user account, the digital token to validate access to the encrypted digital content of the device, based on the identifier of the encrypted digital content;
a processor coupled to a power source; and
a memory, coupled to the processor to store executable instructions,
the executable instructions to:
validate the user account; responsive to validation of access to the encrypted digital content of the device, via the digital token, decrypt and decode the encrypted digital content for output of the encrypted digital content to the authenticated user account; and
download and store the decrypted digital content to the memory responsive to when the user account is authenticated.

2. The system of claim 1, wherein the device has a rotatable bezel and a rotary encoder coupled to the rotatable bezel, the rotatable bezel has a substantially central opening, the GUI is located in the substantially central opening of the rotatable bezel.

3. The system of claim 2, wherein the rotatable bezel has one or more protrusion structures configured to be gripped by a user during rotation of the rotatable bezel.

4. The system of claim 1, further comprising an audio system.

5. The system of claim 4, wherein the audio system is a near-ear audio system.

6. The system of claim 4, wherein a light emitting unit implementing the audio system.

7. A set of headphones implementing the system of claim 1, wherein the set of headphones comprising:
a headband;
a first ear cup connected to a first end of the headband;
a second ear cup connected to a second end of the headband;
the GUI disposed at the first ear cup;
a rotatable bezel connected to the first ear cup;
a first ear pad connected to the first ear cup; and
a second ear pad connected to the second ear cup.

8. The system of claim 7, wherein the headband further comprising:
a capacity-wearing detector configured to power off the GUI when the set of headphones are worn on a user's head, and to illuminate the GUI when the set of headphones are removed.

9. The system of claim 7, wherein the headband further comprising:
one or more sensors in communication with the processor.

10. The system of claim 9, wherein the one or more sensors, including at least one accelerometer, gyroscope, or inertial measurement unit (IMU), configured to detect one or more user body movements and transmit the one or more user body movements to the processor to activate a modification in interactive storytelling.

11. The system of claim 1, wherein the digital content management system, comprising:
an object;
an NFC tag located at the object, the NFC tag with one or more encrypted data links associated with the digital content; and
a remote NFC reader, the NFC tag to transmit the one or more encrypted data links to the remote NFC reader when the object is located within a predetermined proximity to the remote NFC reader.

12. The system of claim 1, wherein the digital content management system, comprising:
an electronic display device;
a graphic user interface (GUI) accessible via the electronic display device; and
an application platform to operate through the GUI, the application platform with one or more encrypted data links associated with the digital content of the digital content management system.

13. An near-ear audio system, comprising:
a set of headphones, comprising:
a headband;
a first ear cup connected to a first end of the headband;
a second ear cup connected to a second end of the headband; and
a control system comprising:
a graphical user interface (GUI) disposed at the first ear cup;
a rotatable bezel connected to the first ear cup; and
a rotary encoder coupled to the rotatable bezel; and
a digital content management system comprising:
a database of digital content;
a user authentication system;
a processor coupled to a power source; and
a memory, coupled to the processor to store executable instructions,
the executable instructions to:
instructions to validate a user;
instructions to download and store the digital content to the memory responsive to when the user is authenticated; and
instructions to decrypt and decode the digital content for output of the digital content, via the near-ear audio system, to an authenticated user.

14. The near-ear audio system of claim 13, wherein the rotatable bezel has a substantially central opening, the GUI is located in the substantially central opening of the rotatable bezel.

15. The near-ear audio system of claim 13, wherein the rotatable bezel has one or more protrusion structures configured to be gripped by the user during rotation of the rotatable bezel.

16. The near-ear audio system of claim 13, further comprising:
a security code assigned to the set of headphones;
a user authentication system comprising:
a user account in communication with the security code of the set of headphones to authenticate the user account;
a digital content management system comprising:
a database of digital content, the digital content is associated with an identifier; and
a digital token assigned to the user account, the digital token to validate access to the digital content of the set of headphones, based on the identifier of the digital content;
the executable instructions further to:
validate the user account;
download and store the digital content to the memory responsive to when the user account is authenticated; and
responsive to validation of access to the digital content of the set of headphones, via the digital token, decrypt and decode the digital content for output of the digital content to the authenticated user account when the digital token.

17. The near-ear audio system of claim 13, wherein the set of headphones further comprising:
one or more sensors in communication with the processor.

18. A device, comprising:
an audio system;
a security code assigned to the device;
a control system comprising:
a graphical user interface (GUI);
a user authentication system comprising:
a user account in communication with the security code of the device to authenticate the user account;
a digital content management system comprising:
a database of digital content, the digital content is associated with an identifier; and
a digital token assigned to the user account, the digital token to validate access to the digital content of the device, based on the identifier of the digital content;
a processor coupled to a power source; and
a memory, coupled to the processor to store executable instructions,
the executable instructions to:
validate the user account;
download and store the digital content to the memory responsive to when the user account is authenticated; and
responsive to validation of access to the digital content of the device, via the digital token, decrypt and decode the digital content for output of the digital content, via the audio system, to the authenticated user account when the digital token.

19. The device of claim 18, wherein the digital content management system, comprising:
an object;
an NFC tag located at the object, the NFC tag with one or more encrypted data links associated with at least the digital content; and
a remote NFC reader, the NFC tag to transmit the one or more encrypted data links to the remote NFC reader when the object is located within a predetermined proximity to the remote NFC reader.

20. The device of claim 18, wherein the digital content management system, comprising:
an electronic display device;
a graphic user interface (GUI) accessible via the electronic display device; and
an application platform to operate through the GUI, the application platform with one or more encrypted data links associated with the digital content of the digital content management system.

21. The device of claim 19, wherein the NFC tag is configured to initiate connection between the device to one or more local networks of one or more devices.

22. The device of claim 19, wherein the NFC tag is configured to allows multiplayer and multidevice features to be activated.

23. The device of claim 19, wherein the NFC tag is configured to delete at least a portion of data retained on the device.
